(19) United States
(12) Patent Application Publication
(10) Pub. No.: US 2025/0358884 A1
(43) Pub. Date: Nov. 20, 2025

(54) ENHANCED MITIGATION OF CU-UP FAILURE TO MAINTAIN SERVICE CONTINUITY

(71) Applicant: Dell Products L.P., Round Rock, TX (US)

(72) Inventors: Hemant Kumar Bhawarlal Jain, Bangalore (IN); Prashanth Murthy, Plano, TX (US)

(21) Appl. No.: 18/667,731

(22) Filed: May 17, 2024

(51) Int. Cl. H04W 76/19; H04W 24/04

(52) U.S. Cl. CPC H04W 76/19; H04W 24/04

(57) ABSTRACT

Failure of an active CU-UP can be managed and mitigated. In connection with an active CU-UP serving a device using a service, CU-CP can employ a node manager component (NMC) that, in connection with failure of active CU-UP, can synchronize operational state parameters, including user plane protocol state parameters, associated with active CU-UP with standby CU-UP, and transition from active CU-UP to standby CU-UP to become an active CU-UP that can serve the device, to maintain service continuity for the device. NMC can inform RAN SMO to reconfigure transport network to switch downlink data and uplink data to standby CU-UP. Standby CU-UP can buffer downlink data and uplink data in buffer memory until the synchronization is completed, after which the formerly standby, now active, CU-UP can communicate buffered downlink data to DU for communication to the device, and buffered uplink data to UPF for communication to a desired destination.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise: in response to determining a first active central unit-user plane node serving a device has failed, synchronizing, by a system comprising at least one processor, a second operational state of a standby central unit-user plane node to a first operational state of the first active central unit-user plane node, comprising synchronizing a group of user plane protocol state parameter values associated with the first active central unit-user plane node and the device with the standby central unit-user plane node, to enable the standby central unit-user plane node to transition to being a second active central unit-user plane node serving the device and to provide service continuity to the device. The method also can comprise: based on the synchronizing, transitioning, by the system, serving of the device from the first active central unit-user plane node to the second active central unit-user plane node.

In certain embodiments, the disclosed subject matter can comprise a system that can comprise at least one memory that can store computer executable components, and at least one processor that can execute computer executable components stored in the at least one memory. The computer executable components can comprise a synchronizer that, in response to determining that a first active central unit-user plane node serving a user equipment has failed, can synchronize a second operational state of a standby central unit-user plane node with a first operational state of the first active central unit-user plane node, comprising synchronization of a group of user plane protocol state parameter values associated with the first active central unit-user plane node and the user equipment with the standby central unit-user plane node, to enable the standby central unit-user plane node to be switched to being a second active central unit-user plane node serving the user equipment and provide service continuity to the user equipment. The computer executable components also can comprise a node switcher that can switch serving of the user equipment from the first active central unit-user plane node to the second active central unit-user plane node, based on the synchronizing.

In still other embodiments, the disclosed subject matter can comprise a non-transitory machine-readable medium, comprising executable instructions that, when executed by at least one processor, can facilitate performance of operations. The operations can comprise: in response to determining a first active central unit-user plane node serving a user equipment has failed, synchronizing a second operational state of a standby central unit-user plane node with a first operational state of the first active central unit-user plane node, comprising synchronizing a group of packet-data-convergence-protocol state parameter values associated with the first active central unit-user plane node and the user equipment with the standby central unit-user plane node, to facilitate transitioning of the standby central unit-user plane node to become a second active central unit-user plane node serving the user equipment and to provide service continuity to the user equipment. The operations also can comprise: based on the synchronizing, transitioning serving of the user equipment from the first active central unit-user plane node to the second active central unit-user plane node.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably perform and manage central unit-user plane (CU-UP) failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter.

FIG. 2 depicts a block diagram of a non-limiting example node manager component, in accordance with various aspects and embodiments of the disclosed subject matter.

FIG. 3 illustrates a block diagram of a non-limiting example system that can desirably perform and manage CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter.

FIG. 4 depicts a block diagram of a non-limiting example system that can relate to CU-UP interaction with the transport network via a service management and orchestration (SMO) component.

FIG. 5 presents a diagram of a non-limiting CU-UP synchronization and transition process flow that can facilitate desirably performing and managing CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter.

FIG. 6 presents a diagram of a portion of a non-limiting CU-UP synchronization and transition process flow that can facilitate desirably performing and managing CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter.

FIG. 7 presents a diagram of a non-limiting example status request message, in accordance with various aspects and embodiments of the disclosed subject matter.

FIG. 8 presents a diagram of a non-limiting example status response message, in accordance with various aspects and embodiments of the disclosed subject matter.

FIG. 9 presents a diagram of a non-limiting example status update request message, in accordance with various aspects and embodiments of the disclosed subject matter.

FIG. 10 presents a diagram of a non-limiting example status update response message, in accordance with various aspects and embodiments of the disclosed subject matter.

FIG. 11 depicts a diagram of a non-limiting example new radio-user plane (NR-UP) downlink user data (NR-UP DUD) packet that can comprise a packet data convergence protocol (PDCP) sequence number (SN) status report indicator that can be sent to a distributed unit (DU) to request a PDCP SN status report be provided, in accordance with various aspects and embodiments of the disclosed subject matter.

FIG. 12 depicts a diagram of a non-limiting example NR-UP downlink data delivery status (NR-UP DDDS) packet that can comprise a PDCP SN status report, comprising the desired user plane protocol state parameter values and/or other parameter values, that can be sent by the DU to a CU-control plane (CP), in accordance with various aspects and embodiments of the disclosed subject matter.

FIG. 13 illustrates a block diagram of non-limiting example system that can comprise the RAN, which can comprise the node manager component that can desirably perform and manage CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter.

FIG. 14 depicts a diagram of a non-limiting example base station that can desirably facilitate connections and communication of information associated with devices, in accordance with various aspects and embodiments of the disclosed subject matter.

FIG. 15 illustrates a diagram of a non-limiting example device that can be operable to engage in a system architecture that facilitates wireless communications according to one or more embodiments described herein, in accordance with various aspects and embodiments of the disclosed subject matter.

FIG. 16 illustrates a flow chart of an example method that can desirably perform and manage CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter.

FIG. 17 depicts a flow chart of another example method that can desirably perform and manage CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter.

FIG. 18 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to management of transitions (e.g., switching) between an active central unit-user plane (CU-UP) associated with a device and a standby CU-UP of a radio access network (RAN) of a communication network (e.g., communication network comprising a core network that can facilitate wireless communication of information between devices, including wireless devices) to mitigate failure of the active CU-UP and maintain service continuity for the device. A device, such as a mobile device (e.g., user equipment (UE), smart phone, or other mobile wireless device), can connect (e.g., wirelessly connect) to a cell (e.g., cell of a base station) or other access point associated with the RAN of the communication network to facilitate connection to the communication network. The device, via connection to the RAN and communication network, can utilize various types of services and applications of or associated with the communication network, and can simultaneously or concurrently access multiple services.

With regard to fifth generation (5G) or other new radio (NR) generation (e.g., xG, wherein x can be a number greater than 5), a RAN can comprise one or more base stations, such as a gNodeB (gNB), wherein the base station can be disaggregated into a CU-UP (e.g., gNB-CU-UP), a CU-control plane (CP) (e.g., gNB-CU-CP), and a distributed unit (DU) (e.g., gNB-DU). The CU-UP and DU can be part of the user plane node, with the CU-UP hosting packet data convergence protocol (PDCP) and service data adaption protocol (SDAP) entities, and the DU can host the radio link control (RLC), medium access control (MAC), and physical (PHY) layers. The base station also can comprise a radio unit (RU) that can be associated with the DU and/or other components of the base station.

With the cloudification of RANs, a RAN can be an open RAN (O-RAN), where there can be several deployment options for operating split base station components, which commonly can be known as O-RAN (O)-CU-UP, O-CU-CP, O-DU, and O-RU. One such deployment option can be a cloud RAN (C-RAN) deployment where the O-CU-UP, O-CU-CP, and DU instances can be deployed in an edge cloud or a centralized data center, with the O-DU connected to the radio (e.g., O-RU) through a fronthaul transport network. Given that the O-DU, O-CU-UP, and O-CU-CP are not stateless and the contexts of the served devices span several protocol layers across the split base station, failure of any of the RAN instances can lead to or result in undesirable service degradation and/or disruption.

With some existing techniques for handling failure of a RAN instance, such as a failure of CU-UP (e.g., O-CU-UP) in a RAN (e.g., C-RAN), to handle the CU-UP failure in the RAN, an existing approach can be to define N+1/M redundancy for the CU-UPs such that there can be an extra or redundant CU-UP that can periodically synchronize with an active CU-UP serving a device. If the active CU-UP fails, the redundant CU-UP can become an active CU-UP that can take over serving of the device. One significant problem with such existing techniques for handling failure of a RAN instance, such as CU-UP failure, can be disruption or failure of service for an existing device that was associated with the active CU-UP when it failed. For instance, the device can be associated with the active CU-UP and DU. When the active CU-UP fails, the user plane path (e.g., the path between the active CU-UP and the user plane function of the core network, and between the active CU-UP and DU) also can fail. This can lead to or result in service failure for the devices, including the device, that can be on (e.g., served by) the failed CU-UP.

With some existing techniques, when the CU-CP associated with the active CU-UP associated with the device has failed, the CU-CP can release the device from the DU and the core network (e.g., 5G or other NR core network). For example, the CU-CP can identify the device (e.g., user equipment (UE)) and associated data radio bearer (DRB) present on the active CU-UP and can perform a partial reset. As part of the partial reset, the active CU-UP can request release of the device from the DU using a reset procedure, such as an F1 application protocol (F1AP) reset procedure, and the active CU-UP can request release of the device from the access and mobility management function (AMF) of the core network using another desired procedure, such as an NG application protocol (NGAP) reset procedure. While, when using existing techniques, the CU-CP ultimately may be able to synchronize the redundant CU-UP so that the redundant CU-CP can become an active CU-UP that can serve the device, there can be undesirable service failure (e.g., lack of service continuity) experienced by the device.

As stated, the CU-UP is not stateless. Accordingly, for a desirable (e.g., suitable, efficient, reliable, or optimal) high availability (HA) solution that can provide desirable service continuity to the device that can mitigate (e.g., minimize, reduce, or eliminate) service degradation or disruption with respect to the device, when there is a failure of an active CU-UP associated with (e.g., serving) a device, it can be desirable (e.g., wanted or required) to synchronize the state between the failed active CU-UP and the redundant CU-UP, because without proper synchronization of the state between the failed active CU-UP and the redundant CU-UP, the redundant CU-UP would not be able to provide the desired service continuity to the device when the redundant CU-UP takes over, or at least attempts to take over, as an active CU-UP serving the device.

For the redundant CU-UP to properly (e. g., suitably, efficiently, reliably, or optimally) become active and serve, and provide desired service continuity to, the device that had been connected to the failed active CU-UP, it can be desirable (e.g., wanted, needed, suitable, or optimal) to synchronize, between the failed active CU-UP and the redundant CU-UP, at least the following information, which can include CU-UP configuration (e.g., CU-UP configuration parameters), device configuration (e.g., user or UE configuration parameters), and user plane protocol state parameters (e.g., user plane protocol or PDCP state parameters or variables). The CU-UP configuration can be synchronized between the failed active CU-UP and the redundant CU-UP relatively easily as the CU-UP configuration typically may not change regularly (e.g., usually does not change often). The device configuration typically can be synchronized between the failed active CU-UP and the redundant CU-UP relatively easily as a CU-UP usually can be aware of the current device configuration.

However, synchronization of the user plane protocol (e.g., PDCP) state parameters between the failed active CU-UP and the redundant CU-UP can be more challenging and problematic, as the user plane protocol state parameters can change frequently, and may even change from data packet to data packet or with small periodicity. One significant problem with synchronizing, or attempting to synchronize, the user plane protocol state parameters between the failed active CU-UP and the redundant CU-UP, where such parameters can change frequently, and may even change from data packet to data packet or with small periodicity, each time such changes in those parameters occur can be that such synchronization or attempted synchronization can be undesirably inefficient and/or infeasible, and/or may not even be possible, as significant network resources may be expended, and/or undesirably inefficient or complex operations, may have to be performed in order to attempt to synchronize such parameters each and every time such changes in those parameters occur. It is noted that, in a CU-UP, PDCP typically can be the only protocol that can maintain state variables.

The user plane protocol state parameters (e.g., user plane protocol state parameter values or variables) to be synchronized between the failed active CU-UP and the redundant CU-UP, to facilitate desirable transition of the redundant CU-UP to becoming an active CU-UP that can serve the device, can comprise, for example, a next transmission value (TX_NEXT), a next reception value (RX_NEXT), a reception delivery value (RX_DELIV), and a reception reorder value (RX_REORD). TX_NEXT can be a state variable that can indicate the count value of the next PDCP service data unit (SDU) that is to be transmitted. RX_NEXT can be a state variable that can indicate the count value of the next PDCP SDU that is expected to be received. RX_DELIV can be a state variable that can indicate the count value of the first PDCP SDU that has not been delivered to the upper network layers, but is still being waited for. RX_REORD can be a state variable that can indicate the count value following the count value associated with the PDCP data PDU for which a reordering timer (e.g., t-reordering timer) was triggered. As stated, when an active CU-UP associated with (e.g., serving) a device fails, without proper synchronization of the state (e.g., including the CU-UP configuration, device configuration, and the user plane protocol state parameter values) between the failed active CU-UP and the redundant CU-UP, the redundant CU-UP will not be able to suitably (e.g., acceptably, efficiently, reliably, or optimally) serve, and provide the desired service continuity to, the device when the redundant CU-UP takes over, or at least attempts to take over, as an active CU-UP serving the device.

Existing techniques for switching from a failed active CU-UP to having a redundant CU-UP serve a device may not be able to synchronize the CU-UP configuration, device configuration, and user plane protocol state parameters between the failed active CU-UP and the redundant CU-UP without having to perform a reset (e.g., a partial reset) that can result in the active CU-UP requesting release of the device from the DU and requesting release of the device from the AMF of the core network, which can result in the respective release of the device from the DU and the AMF, such as described herein. This can result in an undesirable lack or failure of service continuity for the device, which can include undesirable service disruption and/or degradation being experienced by the device.

The disclosed subject matter can address and overcome these and other deficiencies and challenges of the existing techniques with regard to handling failure of an active CU-UP associated with a device. In that regard, it can be desirable (e.g., wanted, useful, advantageous, beneficial, and/or optimal) to provide a well-defined HA solution to mitigate (e.g., reduce or minimize) the service failure, degradation, and/or disruption, and desirably maintain service continuity for the device when there is a failure of an active CU-UP associated with the device. It can be desirable to synchronize the states (e.g., operational states) of various parameters (e.g., CU-UP configuration, device configuration, and user plane protocol state parameters or variables) associated with a standby (e.g., redundant or extra) CU-UP with the active CU-UP, with respect to the device, when the active CU-UP fails such that the standby CU-UP can become an active CU-UP serving the device and service continuity can be desirably maintained for the device. It further can be desirable to synchronize the states of the various parameters associated with the standby CU-UP with the active CU-UP, and transition the standby CU-UP to an active CU-UP for the device without having to perform any reset that results in a release of the device from the DU or any reset that results in a release of the device from the AMF, as such resets and releases can result in undesirable failure, degradation, and/or disruption of service for the device.

The disclosed subject matter can employ enhanced CU-UP failure mitigation techniques that can enable a RAN (e.g., a CU-CP and/or other component(s) of the RAN) to provide a well-defined HA solution to mitigate (e.g., reduce or minimize) service failure, degradation, and/or disruption, and desirably maintain service continuity for the device when there is a failure of an active CU-UP associated with the device. The enhanced CU-UP failure mitigation techniques also can enable the RAN to synchronize the states of various parameters (e.g., CU-UP configuration, device configuration, and user plane protocol state parameters or variables) associated with a standby CU-UP with the active CU-UP, with respect to the device, when the active CU-UP fails such that the standby CU-UP can become an active CU-UP serving the device and service continuity can be desirably maintained for the device. Further, the enhanced CU-UP failure mitigation techniques also can enable the RAN to synchronize the states of the various parameters associated with the standby CU-UP with the active CU-UP, and transition the standby CU-UP to an active CU-UP for the device without having to perform any reset that can result in the release of the device from the DU or any reset that can result in the release of the device from the AMF, to mitigate undesirable failure, degradation, and/or disruption of service for the device, and desirably maintain service continuity for the device.

To that end, techniques that can desirably (e.g., automatically, dynamically, suitably, reliably, efficiently, enhancedly, and/or optimally) perform and manage CU-UP failure mitigation, including synchronizing an active CU-UP and a standby CU-UP, and transitioning from the active CU-UP to the standby CU-UP to serve a device when the active CU-UP fails, are presented. A system can comprise a communication network that can comprise a core network and one or more RANs that can be associated with (e.g., communicatively connected to) the core network. A RAN can comprise a CU-CP, a group of CU-UPs, a group of DUs, and a group of RUs. A device can be associated with (e.g., wirelessly communicatively connected to) the RAN, where the device can be utilizing a service of or associated with the communication network. While associated with the RAN, the device can be served by an active CU-UP and a DU, associated with the active CU-UP and the device, to facilitate use of the service by the device, including data communication between the device and the service. The RAN also can comprise a standby CU-UP (e.g., redundant or extra CU-UP) that, at desired times, can be synchronized (e.g., periodically, dynamically, or automatically synchronized) with the active CU-UP. The active CU-UP and standby CU-UP can be associated with the CU-CP.

In accordance with various embodiments, the CU-CP can comprise or be associated with a node manager component that can manage (e.g., handle or control) and mitigate (e.g., reduce or minimize the effects of) failure of a first active CU-UP (e.g., CU-UP node) associated with the device, if the first active CU-UP fails, by synchronizing the standby CU-UP with the first active CU-UP (e.g., with respect to each DRB of one or more DRBs associated with each device of one or more devices), and transitioning the standby CU-UP to become a second active CU-UP that can serve the device (e.g., with respect to provision of the service), while desirably maintaining service continuity for the device. For instance, a device can be utilizing a service, wherein the first active CU-UP can be serving the device. If the first active CU-UP serving the device is determined or detected to be experiencing a failure condition, the CU-CP can employ a node manager component that, in connection with failure of the first active CU-UP, can synchronize, and/or can facilitate, initiate, and/or manage synchronization of, operational state parameters, including user plane protocol state parameters (e.g., uplink PDCP sequence number (SN), downlink PDCP SN, and/or other parameters), associated with the first active CU-UP and the device (e.g., with respect to each DRB of one or more DRBs associated with each device of one or more devices) with a standby CU-UP. The node manager component can obtain at least some of the user plane protocol state parameters from the DU associated with the failed first active CU-UP, and can provide at least some of the user plane protocol state parameters (e.g., uplink PDCP SN, downlink PDCP SN, and/or other parameters) to the standby CU-UP to facilitate the synchronization. The standby CU-UP can update and/or synchronize its operational status based at least in part on the user plane protocol state parameters and/or other parameters received from the CU-CP (e.g., the node manager component of the CU-CP).

The node manager component also can inform or instruct a service management and orchestration (SMO) component (e.g., a RAN SMO of the SMO component) to reconfigure the transport network to switch the downlink data path and the uplink data path from the failed first active CU-UP to the standby CU-UP. After the downlink data path and the uplink data path have been switched to the standby CU-UP, if the synchronization process is still ongoing, the standby CU-UP can receive downlink data associated with the device from the UPF of the core network via the downlink data path, and uplink data associated with the device from the DU via the uplink data path, wherein the standby CU-UP can buffer the downlink data and the uplink data in a buffer component (e.g., buffer memory) until the synchronization process is completed. After the synchronization process is complete, the standby CU-UP, as transitioned to becoming the second active CU-UP, can communicate the buffered downlink data and/or any subsequently received downlink data to the DU for communication to the device, and can communicate the buffered uplink data and/or any subsequently received uplink data to the UPF for communication to a desired destination (e.g., another device or service, or other desired destination).

The disclosed subject matter, by employing the node manager component and the techniques described herein, can desirably (e.g., suitably, efficiently, enhancedly, or optimally) synchronize the states (e.g., operational states) of various parameters (e.g., first active CU-UP configuration, device configuration, and user plane protocol state parameters or variables) associated with the standby CU-UP with the first active CU-UP, with respect to the device (and/or one or more associated DRBs), when the first active CU-UP fails such that the standby CU-UP can be transitioned to become the second active CU-UP serving the device to desirably manage and mitigate the failure of the first active CU-UP associated with the device while desirably maintaining service continuity for the device and mitigating (e.g., eliminating, reducing, or minimizing) service failure, degradation, and/or disruption of the service with respect to the device. The disclosed subject matter, by employing the node manager component and the techniques described herein, also can desirably (e.g., suitably, efficiently, enhancedly, or optimally) synchronize the states of the various parameters associated with the standby CU-UP with the failed first active CU-UP, and transition the standby CU-UP to become the second active CU-UP with respect to the device (and the one or more DRBs associated therewith), without having to perform any reset that can result in a release of the device from the DU or any reset that can result in a release of the device from the AMF of the core network. It can be desirable to perform such synchronization and transitioning without having to perform any such resets and releases, as such resets and releases can result in undesirable failure, degradation, and/or disruption of service for the device. The disclosed subject matter, by employing the node manager component and the techniques described herein, can thereby provide enhanced performance of the device, the service, and the communication network, as compared to existing techniques for handling failure of active CU-UP serving a device.

These and other aspects and embodiments of the disclosed subject matter will now be described with respect to the drawings.

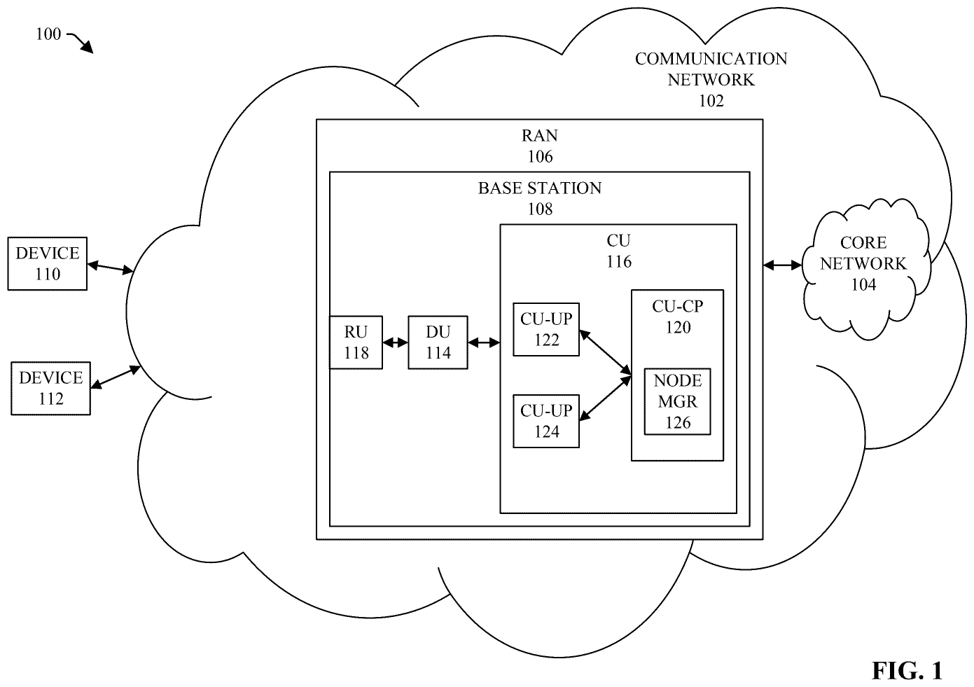

Referring now to the drawings, FIG. 1 illustrates a block diagram of a non-limiting example system 100 that can desirably (e.g., automatically, dynamically, suitably, reliably, efficiently, enhancedly, and/or optimally) perform and manage CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter. The system 100 can comprise a communication network 102 that can comprise a core network 104 and one or more RANs, such as RAN 106, that can be associated with (e.g., communicatively connected to) the core network 104. Each RAN (e.g., RAN 106) can comprise one or more base stations, such as, for example, base station 108, that each can comprise one or more cells.

The core network 104, the one or more RANs (e.g., RAN 106), the one or more base stations (e.g., base station 108), and the one or more cells can facilitate (e.g., enable) wireless communication of data (e.g., voice or other audio data, video data, textual data, or other data) between devices (e.g., communication devices or UEs), such as devices associated with the core network 104, via the one or more RANs, one or more base stations, and one or more cells, and other devices associated with the core network 104 or, more generally, the communication network 102 (e.g., a device, such as a server or computer, can be connected to the communication network 102 via a wireline connection or via a network other than the core network 104).

The devices can comprise, for example, devices 110 and/or 112. A device (e.g., 110 or 112) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term user equipment (UE) can be used to describe the device. The device (e.g., 110 or 112) can be associated with (e.g., communicatively connected to) the communication network 102 via a communication connection and channel, which can include a wireless or wireline communication connection and channel.

In accordance with various embodiments, the core network 104 can comprise various network components that can facilitate wireless communication of data. In some embodiments, the RAN 106 can be a 5G or other NR RAN (e.g., gNB or other NR-type or xG RAN, wherein x can be a number greater than 5), and/or the base station(s) (e.g., base station 108) can be a 5G or other NR base station (e.g., gNB or other NR-type or xG base station, wherein x can be a number greater than 5). In certain embodiments, the core network 104 can comprise a UPF node, an access and mobility management function (AMF) node, and/or other network functions (not shown in FIG. 1 for reasons of brevity and clarity). The UPF node can connect to or interface with the one or more RANs (e.g., RAN 106) and the one or more base stations (e.g., base station 108), can be an interconnect point between the core network 104 and a data network (DN), can provide or facilitate providing a protocol data unit (PDU) session anchor point for providing mobility associated with radio access technologies (RATs), can provide or facilitate providing data packet routing or forwarding, and/or can perform or manage other functions. The AMF node can be a control plane function that can manage registration and deregistration of devices (e.g., devices 110 and/or 112) with the core network 104, manage connections of devices with the core network 104, manage mobility associated with devices (e.g., maintain knowledge of locations of devices, update locations of devices), and/or manage or perform other functions. In accordance with various other embodiments, the RAN(s) (e.g., RAN 106) and/or the base station(s) (e.g., base station 108) can be a 4^{th} generation (4G) long term evolution (LTE) RAN or base station, or the RAN or base station can comprise 4G LTE technology and functions, and 5G or other NR-type or xG technology and functions.

The communication network 102, more generally, or the core network 104 can comprise various other network equipment (e.g., routers, gateways, transceivers, switches, access points, network functions, processor components, data stores, or other devices or network nodes) that facilitate (e.g., enable) communication of information between respective items of network equipment of the communication network 102, and/or communication of information between the one or more devices (e.g., devices 110 and/or 112) and the communication network 102. The communication network 102, including the core network 104, can provide or facilitate wireless or wireline communication connections and channels between the one or more devices (e.g., devices 110 and/or 112), and/or respectively associated services or applications, and the communication network 102. For reasons of brevity or clarity, some of the various network equipment, components, functions, or devices of the communication network may not be explicitly shown or described herein.

At various times, the respective devices (e.g., devices 110 and/or 112) can utilize respective services. The services can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

In some embodiments, the RAN 106 can comprise various RAN nodes, including distributed units (DUs), such as DU 114, associated with one or more cells, one or more CUs, such as CU 116, that can be associated with (e.g., communicatively connected to) the respective DUs (e.g., DU 114), and/or one or more radio units (RUs), such as RU 118, that can be associated with the CU(s) 116, and/or other components. In some embodiments, a base station(s) (e.g., base stations 108) of the RAN 106, which also can be referred to as a gNodeB (gNB), can be logically divided into several components, which can allow for flexibility of deployment. For instance, the base station (e.g., base station 108) can comprise a DU(s) 114, which also can be referred to as gNB-DU, the CU 116, which also can be referred to as gNB-CU, and the RU 118, which also can be referred to as gNB-RU. The CU 116 can comprise a CU-CP 120, which also can be referred to as gNB-CU-CP, and a desired number of CU-UPs, such as CU-UP 122 and CU-UP 124, which also can be referred to as gNB-CU-UPs, that can be associated with (e.g., communicatively connected to) the CU-CP 120. The DU 114 can be associated with (e.g., communicatively connected to) the CU 116, including the CU-UPs 122 and/or 124. The CU 116 also can be associated with (e.g., communicatively connected to) the RU 118.

In some embodiments, the CU 116 can employ a redundancy CU-UP framework where there can be one or more CU-UPs (e.g., CU-UP 124) that can act as a standby CU-UP in case an active CU-UP (e.g., CU-UP 122), which is serving a device (e.g., device 110), experiences a failure condition that can disrupt or degrade service for the device. As a non-limiting example, the CU 116 can employ a redundancy CU-UP framework that can comprise or define N+1/M redundancy for the CU-UPs such that there can be one or more extra or redundant CU-UPs that can periodically synchronize with an active CU-UP serving a device, in case the active CU-UP fails, wherein N and M can be desired respective numerical values.

As disclosed, there can be instances where a device can be using a service (or more than one service), where the device can be connected to an active CU-UP via a DU. There also can be a standby CU-UP that can be utilized to take over for the active CU-UP if there is a failure of the active CU-UP. Some existing techniques for switching over from the failed active CU-UP to the standby CU-UP can be deficient in a number of ways, including that, while the CU-CP ultimately may be able to synchronize the state of the failed active CU-UP with the state of the standby CU-UP, such existing techniques can include having the failed active CU-CP performing at least partial reset procedures that can involve releasing the device from the DU and the core network and releasing the device from the AMF of the core network, such as described herein. This can result in an undesirable (e.g., unwanted, inefficient, unsuitable, or suboptimal) lack of service continuity for the device, including undesirable service disruption and/or degradation, such as described herein.

The disclosed subject matter can address and overcome these and other deficiencies, challenges, and problems of the existing techniques with regard to handling failure of an active CU-UP associated with a device. To that end, the system 100 can comprise a node manager component (NODE MGR) 126 that can desirably (e.g., automatically, dynamically, suitably, reliably, efficiently, enhancedly, and/or optimally) perform and manage CU-UP failure mitigation, including synchronizing an active CU-UP (e.g., CU-UP 122) and a standby CU-UP (e.g., CU-UP 124), and transitioning from the active CU-UP to the standby CU-UP to serve a device (e.g., device 110) when the active CU-UP fails, in accordance with defined node management criteria. In some embodiments, the node manager component 126 can be part of the CU 116 (as depicted), such as described herein. In other embodiments, the node manager component 126 can be a standalone component or part of another component, such as a controller (e.g., a RAN intelligent controller (RIC) or other type of controller), associated with the RAN(s)), and/or can be located or situated elsewhere in or associated with the communication network 102, wherein the node manager component 126 can be associated with (e.g., communicatively connected to) the CU-CP 120 and/or the CU-UPs 122 and 124.

There can be an example scenario where the device 110 can be connected (e.g., wirelessly connected) to the RAN 106 (e.g., base station 108 of the RAN 106) via the DU 114 and RU 118. The device 110 can be connected to the RAN 106 to utilize a service of or associated with the communication network 102 (e.g., a service associated with the device 112, or a service that can be provided by the communication network 102). The CU-UP 122 can be associated with (e.g., communicatively connected to) the DU 114, and can be a first active CU-UP that can serve the device 110 to facilitate utilization of the service by the device 110.

In some embodiments, the node manager component 126 can determine or detect when the first active CU-UP 122 has failed (e.g., has experienced a failure condition). For instance, the first active CU-UP 122 can experience a failure condition, wherein the node manager component 126 can detect, determine, and/or be notified that the first active CU-UP 122 is experiencing the failure condition. The failure condition can be, for example, a stream control transport protocol (SCTP) failure or other type of failure of the first active CU-UP 122. In certain embodiments, in response to determining that the first active CU-UP 122 has experienced the failure condition, the node manager component 126 can synchronize, manage (e.g., control) synchronization of, and/or facilitate or initiate synchronizing of, a second operational state of the standby CU-UP 124 to or with a first operational state of the first active CU-UP 122, the synchronizing comprising synchronizing of a group of user plane protocol state parameter values (e.g., PDCP parameter values or variables) and other state parameter values (e.g., first active CU-UP configuration values, device configuration values of the device 110) associated with the first active CU-UP 122 and the device 110 with the standby CU-UP 124, to enable the standby CU-UP 124 to transition to being a second active CU-UP 124 serving the device 110 and desirably provide service continuity to the device 110, such as described herein. Based at least in part on, and in response to, the synchronizing of the second operational state of the standby CU-UP 124 to or with the first operational state of the first active CU-UP 122, the node manager component 126 can transition or facilitate transitioning from the first active CU-UP 122 serving the device 110 to the second active CU-UP 124 serving the device 110 (e.g., with regard to the service).

The disclosed subject matter, by employing the node manager component 126 and the techniques described herein, can desirably (e.g., suitably, efficiently, enhancedly, or optimally) synchronize the states (e.g., operational states) of various parameters (e.g., first active CU-UP configuration, device configuration, and user plane protocol state parameters or variables) associated with the standby CU-UP 124 with the first active CU-UP 122, with respect to the device 110, when the first active CU-UP 122 fails such that the standby CU-UP 124 can be transitioned to become the second active CU-UP 124 serving the device 110. The disclosed subject matter, by employing the node manager component 126 and the techniques described herein, also can desirably synchronize the states of the various parameters associated with the standby CU-UP 124 with the first active CU-UP 122, and transition the standby CU-UP 124 to become the second active CU-UP 124 for the device 110 without having to perform any reset that can result in a release of the device 110 from the DU 114 or any reset that can result in a release of the device 110 from the AMF of the core network 104. Such synchronization and transitioning performed, managed, and/or facilitated by the node manager component 126 and/or other components utilizing the techniques described herein can desirably manage and mitigate the failure of the first active CU-UP 122 associated with the device 110 by desirably maintaining service continuity for the device 110 when there is failure of the first active CU-UP 122 and mitigating (e.g., eliminating, reducing, or minimizing) service failure, degradation, and/or disruption of the service with respect to the device 110.

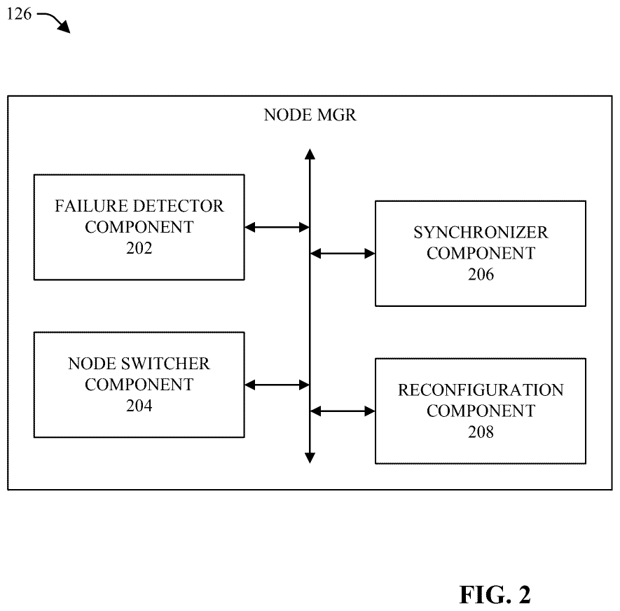

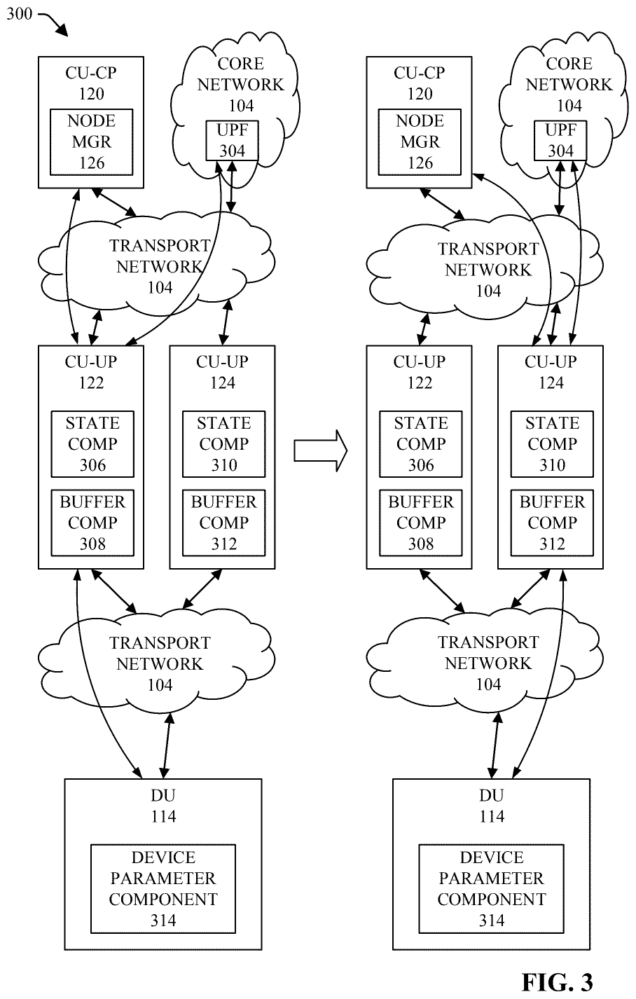

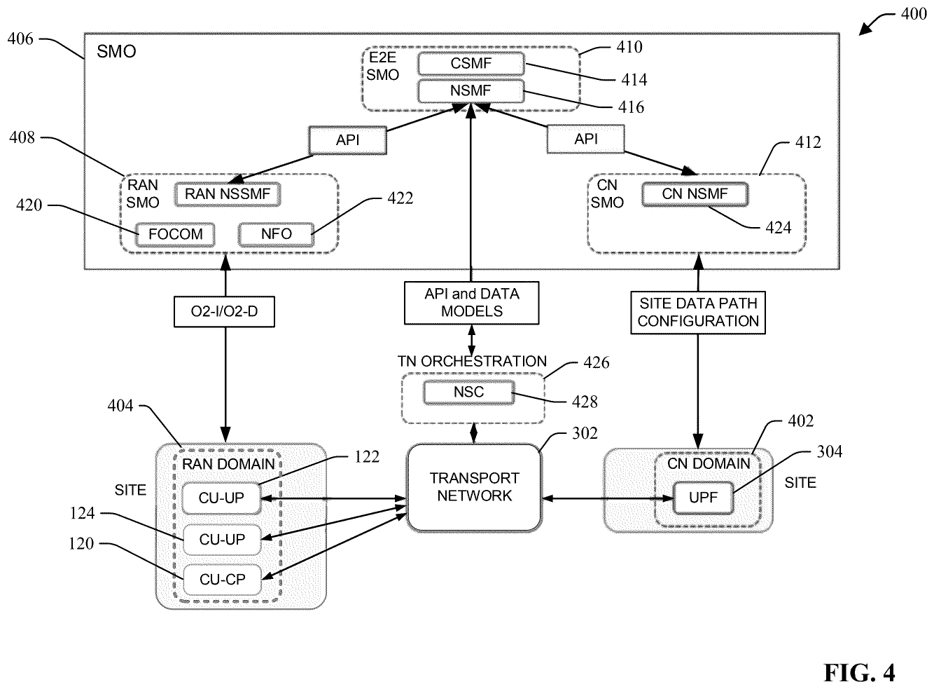

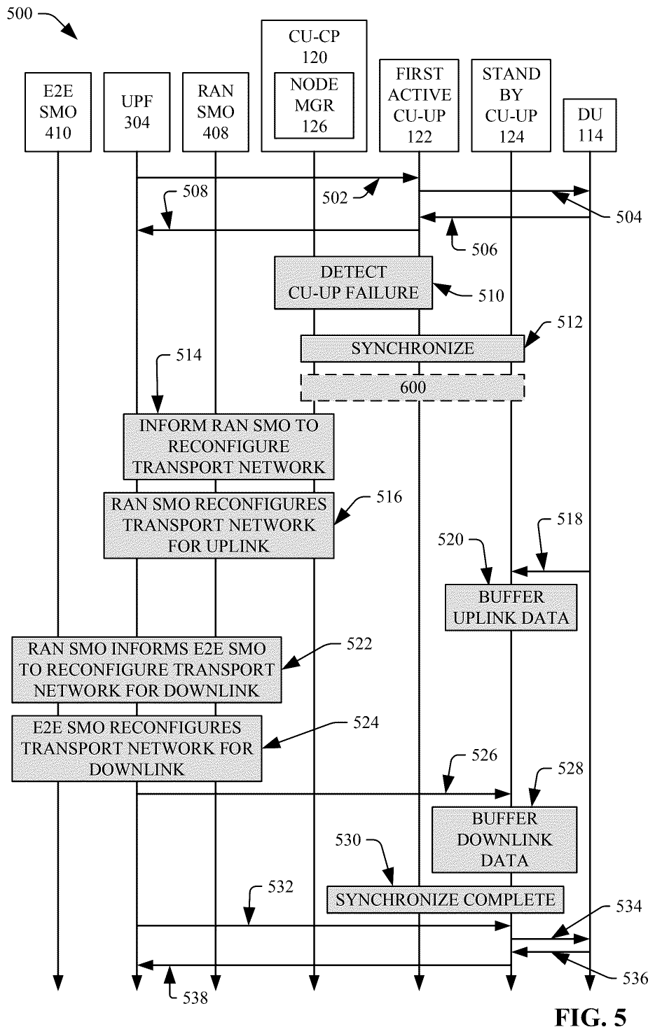

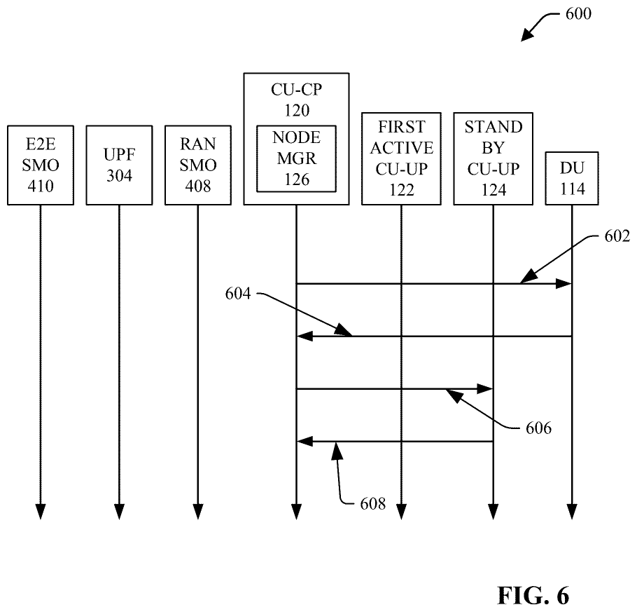

Referring to FIGS. 2-6 (along with FIG. 1), FIG. 2 depicts a block diagram of a non-limiting example node manager component 126, FIG. 3 illustrates a block diagram of a non-limiting example system 300 that can desirably (e.g., automatically, dynamically, suitably, reliably, efficiently, enhancedly, and/or optimally) perform and manage CU-UP failure mitigation, including synchronizing an active CU-UP and a standby CU-UP, and transitioning from the active CU-UP to the standby CU-UP to serve a device when the active CU-UP fails, FIG. 4 depicts a block diagram of a non-limiting example system 400 that can relate to CU-UP interaction with the transport network via the SMO component, FIG. 5 presents a diagram of a non-limiting CU-UP synchronization and transition process flow 500 that can facilitate desirably (e.g., automatically, dynamically, suitably, reliably, efficiently, enhancedly, and/or optimally) performing and managing CU-UP failure mitigation, including synchronizing an active CU-UP and a standby CU-UP, and transitioning from the active CU-UP to the standby CU-UP to serve a device when the active CU-UP fails, and FIG. 6 presents a diagram of a portion of a non-limiting CU-UP synchronization and transition process flow 600 that can facilitate desirably performing and managing CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter. In some embodiments, the system 300 and/or the system 400 can be part of (e.g., a portion of) the system 100 of FIG. 1. In certain embodiments, the portion of the non-limiting CU-UP synchronization and transition process flow 600 depicted in FIG. 6 can be part of the non-limiting CU-UP synchronization and transition process flow 500 depicted in FIG. 5.

With regard to FIG. 2, in accordance with various embodiments, the node manager component 126 can comprise a failure detector component 202, a node switcher component 204 (e.g., a CU-UP node switcher or transitioner component), a synchronizer component 206, a reconfiguration component 208, and/or another component, such as described herein.

Regarding FIG. 3 and the system 300, the system 300 can comprise the core network 104, the DU 114, the CU-CP 120, the CU-UP 122, the CU-UP 124, and the node manager component 126. The system 300 also can comprise a transport network 302 that can be associated with (e.g., communicatively connected to) the core network 104, the DU 114, the CU-CP 120, the CU-UP 122, and the CU-UP 124. In certain embodiments, the transport network 302 can comprise, for example, an access layer, an aggregation layer, and a core layer (not shown in FIG. 3) that can be associated with (e.g., communicatively connected to) each other and can comprise respective network components (e.g., routers, switches, nodes, and/or other network components) that can facilitate communication and routing of data (e.g., uplink data, downlink data) to or from various respective components (e.g., DU 114, CU-CP 120, CU-UP 122, CU-UP 124, UPF 304, and/or other component) associated with (e.g., communicatively connected to) the transport network 302. The access layer can be at or near a network edge of the transport network 302 where data traffic can be received from or communicated to or towards devices (e.g., devices 110 and/or 112) and/or other endpoint devices. The access layer can provide network access to devices. The core layer can be at or near the core network 104 and can provide access for data traffic being communicated (e.g., by the device(s) (e.g., device 110 and/or 112), the RAN 106, or other devices or network equipment) to or received from the core network 104. The aggregation layer can be an intermediate transport network layer that can comprise network equipment that can route data traffic between the access layer and the core layer.

The core network 104 can comprise various network components, including the UPF 304. The CU-UP 122 (e.g., the first active CU-UP) can comprise a state component (STATE COMP) 306 and a buffer component (BUFFER COMP) 308. The CU-UP 124 (e.g., the standby CU-UP that can become the second active CU-UP) can comprise a state component 310 and a buffer component 312, such as described herein. The DU 114 can comprise a device parameter component 314, such as described herein.

With regard to FIG. 4 and the system 400, the system 400 can comprise the CU-CP 120, the CU-UP 122, the CU-UP 124, the node manager component 126. The system 400 also can comprise the transport network 302 and the UPF 304 (e.g., UPF of the core network 104). The UPF 304 can be part of the core network (CN) domain 402 of the core network 104. The CU-CP 120, the CU-UP 122, and the CU-UP 124 can be part of the RAN domain 404 of the RAN 106. The system 400 further can comprise an SMO 406 that can be associated with (e.g., communicatively connected to) the RAN 106 (e.g., the RAN domain 404 of the RAN 106), the core network 104 (e.g., the CN domain 402 of the core network 104), and the transport network 302 via respective interfaces and using respective protocols and/or configurations. In some embodiments, the SMO 406 can comprise a RAN SMO 408, an end-to-end (E2E) SMO 410, and a CN SMO 412, wherein the E2E SMO 410 can be associated with (e.g., communicatively connected to) the RAN SMO 408 and the CN SMO 412 via respective interfaces (e.g., respective application programming interfaces (APIs)).

The E2E SMO 410 can be associated with (e.g., communicatively connected to) the transport network 302 via a desired interface. The RAN SMO 408 can be associated with (e.g., communicatively connected to) the RAN 106 (e.g., the RAN domain 404 of the RAN 106) via a desired interface (e.g., an O2 or O2-type interface). The CN SMO 412 can be associated with the core network 104 (e.g., the CN domain 402 of the core network 104) via a desired interface.

In some embodiments, the E2E SMO 410 can comprise a communication service management function (CSMF) 414 and network slice management function (NSMF) 416. The CSMF 414 can translate communication service-related specifications (e.g., requirements) to network slice-related specifications, and can communicate (e.g., transmit or receive) information with the NSMF 416. The NSMF 416 can manage and orchestrate network slice instances (NSIs), determine network slice-related specifications from the network slice-related specifications, and can communicate respective information with the CSMF 414 and a RAN Network slice subnet management function (RAN NSSMF) 418 of the RAN SMO 408. The RAN NSSMF 418 can manage and orchestrate network slice subnet instances (NSSIs) in or for the RAN domain 404.

The RAN SMO 408 also can comprise a federated open cloud orchestration and management (FOCOM) component 420 and a network function orchestration (NFO) component 422. The FOCOM component 420 can perform or facilitate performing provisioning of a RAN site O-cloud, configuring of the RAN site O-cloud, and/or management of the RAN site O-cloud. The NFO component 422 can perform or facilitate performing initial deployment of various components of the RAN 106 (e.g., O-RAN), such as, for example, DU 114 (e.g., O-DU), CU 116 (e.g., O-CU), RIC (e.g., near-realtime RIC), and/or other RAN components, and/or applications, such as, for example, extended applications (xApps) or rApps.

The CN SMO 412 can comprise a CN NSSMF 424 that can comprise and provide subnet management functions and subnet orchestration functions for the CN domain 402 of the core network 104, can perform of facilitate performing deployment and/or mapping of service-related virtual network functions (VNFs), and can communicate information with the NSMF 416 of the E2E SMO 410, among other functions. For instance, the CN NSSMF 424 can manage a subnet of a network slice in the CN domain 402 and/or management of a service in the CN domain 402. The CN NSSMF 424 also can communicate performance information (e.g., performance reports) to the NSMF 416 regarding whether service specifications are being satisfied to enable the NSMF 416 to determine whether, and/or verify that, service specifications are being satisfied.

The system 400 also can comprise a transport network (TN) orchestration component 426 that can be associated with (e.g., communicatively connected to) the SMO 406 (e.g., the NSMF 416 of the E2E SMO 410) and the transport network 302 via a specified interface (e.g., a particular API). The TN orchestration component 426 can comprise a network slice controller (NSC) 428 (e.g., an Internet Engineering Task Force (IETF) NSC (IETF NSC)) that can set up resources and connectivity in the transport network 302 (e.g., for a transport slice) to generate (e.g., create) or realize desired network slice (e.g., for or in connection with a service).

When the CU-CP 120 detects that the first active CU-UP 122 has failed, the CU-CP 120 (e.g., the node manager component 126 of the CU-CP 120) can inform the SMO 406 of such failure of the first active CU-CP 122. In response to such failure, the SMO 406 can initiate (e.g., trigger) the standby CU-UP 124 to take over and become the second active CU-UP 124 for the one or more devices (e.g., device 110), and the one or more associated DRBs, that were being served by the failed first active CU-UP 122, to facilitate desirably maintaining service continuity for the one or more devices (e.g., device 110), such as described herein. The SMO 406 (e.g., the RAN SMO 408 and the E2E SMO 410) can perform the reconfiguration of the transport network 302 (e.g., the NG-U interface and F1-U interface transport network reconfiguration) to have the uplink and downlink data paths switched from the failed first active CU-UP 122 to the standby CU-UP 124 to desirably restore connectivity (e.g., restore NG-U interface and F1-U interface connectivity), to facilitate desirably maintaining service continuity for the one or more devices (e.g., device 110), such as described herein. The NG-U interface can be the interface between the RAN 106 and the core network 104 (e.g., the UPF 304 of the core network 104). The F1-U interface can be the interface between a CU-UP (e.g., first active CU-UP 122 or standby CU-UP124) and a DU (e.g., DU 114).

With regard to FIG. 5 and the CU-UP synchronization and transition process flow 500, the device 110 can be connected to the communication network 102 via the DU 114, wherein the device 110 can be utilizing a desired service, and wherein a first active CU-UP 122 can be serving the device 110 to facilitate utilization of the service by the device 110. The device 110 can be utilizing one or more DRBs in connection with utilization of the service. While the device 110 is utilizing the service, downlink data can be communicated from the UPF 304 to the first active CU-UP 122, as indicated at reference numeral 502, and from the first active CU-UP 122 to the DU 114, as indicated at reference numeral 504, wherein the DU 114 can send the downlink data to the device 110. The device 110 also can communicate uplink data to the DU 114, wherein the DU 114 can communicate the uplink data to the first active CU-UP 122, as indicated at reference numeral 506, and from the first active CU-UP 122 to the UPF 304, as indicated at reference numeral 508, wherein the UPF 304 can forward (e.g., communicate or send) the uplink data to or towards a desired destination (e.g., the device 112, or other desired destination device, node, or component).

As indicated at reference numeral 510 of the CU-UP synchronization and transition process flow 500, the CU-CP 120, employing the failure detector component 202, can determine, detect, or be informed that the first active CU-UP 122 is experiencing a failure condition (e.g., SCTP failure or other type of failure condition). In response to determining that the first active CU-UP 122 is experiencing the failure condition, the CU-CP 120, employing the node switcher component 204, can initiate, facilitate, and/or manage transitioning (e.g., switching) from the failed first active CU-UP 122 serving the one or more devices (e.g., device 110) to having the standby CU-UP 124 becoming the second active CU-UP 124 that can serve the one or more devices.

As indicated at reference numeral 512 of the CU-UP synchronization and transition process flow 500, in response to determining that the first active CU-UP 122 is experiencing the failure condition, and in response to (e.g., in connection with) initiating the transitioning of the standby CU-UP 124 to become the second active CU-UP 124 with respect to each device (e.g., device 110) that was being served by the failed first active CU-UP 122, the CU-CP 120, employing the synchronizer component 206, can synchronize, and/or initiate, facilitate, and/or manage synchronization of, the standby CU-UP 124 with the first active CU-UP 122. For instance, the synchronizer component 206 can synchronize, and/or initiate, facilitate, and/or manage synchronization of, a group of user plane protocol state parameter values (e.g., PDCP parameter values or variables) and other state parameter values (e.g., first active CU-UP configuration values, device configuration values of the device 110) associated with the first active CU-UP 122 and the device 110. In some embodiments, the synchronizer component 206 can determine one or more devices (e.g., a group or list of devices), such as the device 110, that are associated with (e.g., belong to) the failed first active CU-UP 122, and/or one or more DRBs associated with (e.g., utilized by) the one or more devices. The synchronizer component 206 also can determine one or more DUs (e.g., a group or list of DUs), such as DU 114, that can be associated with (e.g., can be hosting) the one or more devices (e.g., device 110). For each DU (e.g., DU 114) of the one or more DUs, the synchronizer component 206 can request that the DU provide PDCP parameter values, such as the last downlink PDCP SN (e.g., of or associated with a last downlink PDU) received from the first active CU-UP 122 and the last uplink PDCP SN (e.g., of or associated with a last uplink PDU) sent to the first active CU-UP 122, with regard to each DRB or the one or more DRBs associated with each device (e.g., device 110) of the one or more devices.

In some embodiments, as part of the synchronizing indicated at reference numeral 512, the CU-CP 120 (e.g., the synchronizer component 206 of the CU-CP 120) can synchronize the user plane protocol state parameter values and/or other parameter values using F1AP and E1 application protocol (E1AP) signaling. For instance, the synchronizer component 206 can employ the portion of the non-limiting CU-UP synchronization and transition process flow 600 to obtain, from each DU (e.g., the device parameter component 314 of the DU 114), the last downlink PDCP SN received from the first active CU-UP 122 and the last uplink PDCP SN sent to the first active CU-UP 122, with regard to each DRB or the one or more DRBs associated with each device (e.g., device 110) of the one or more devices, and provide (e.g., communicate) such parameter values and/or other parameter values to the standby CU-UP 124, to facilitate synchronizing the standby CU-UP 124 with the first active CU-UP 122, such as more fully described herein. In certain other embodiments, as part of the synchronizing indicated at reference numeral 512, the synchronizer component 206 can synchronize the user plane protocol state parameter values and/or other parameter values using an NR-UP process. For instance, the synchronizer component 206 can request and obtain a PDCP SN status report from each DU (e.g., from the device parameter component 314 of the DU 114) of the one or more DUs with regard to each DRB of the one or more DRBs associated with each device (e.g., device 110) of the one or more devices, wherein each PDCP SN status report can comprise the last downlink PDCP SN received from the first active CU-UP 122 and the last uplink PDCP SN sent to the first active CU-UP 122, with regard to each DRB or the one or more DRBs associated with each device (e.g., device 110) of the one or more devices, such as described herein.

The synchronizer component 206 can communicate, to the standby CU-UP 124, the last downlink PDCP SN received from the first active CU-UP 122 and the last uplink PDCP SN sent to the first active CU-UP 122, and/or other parameter values (e.g., the first active CU-UP configuration values, the device configuration values of the device, and/or other parameter values), with regard to each DRB or the one or more DRBs associated with each device (e.g., device 110) of the one or more devices. The standby CU-UP 124 can receive the last downlink PDCP SN received from the first active CU-UP 122 and the last uplink PDCP SN sent to the first active CU-UP 122, and/or the other parameter values from the synchronizer component 206.

The standby CU-UP 124, employing a state component 310, can synchronize (e.g., synchronize state parameter values) with the failed first active CU-UP 122 based at least in part on the last downlink PDCP SN received from the first active CU-UP 122 and the last uplink PDCP SN sent to the first active CU-UP 122, and/or the other parameter values, with regard to each DRB or the one or more DRBs associated with each device (e.g., device 110) of the one or more devices. For instance, with regard to each DRB of the one or more DRBs associated with each device (e.g., device 110 of the one or more devices, the standby CU-UP 124, employing the state component 310, can determine, generate, and/or set various user plane protocol state parameter values, based at least in part on the last downlink PDCP SN and the last uplink PDCP SN. In some embodiments, for each DRB associated with each device (e.g., device 110), the standby CU-UP 124, employing the state component 310, can determine and/or generate an uplink PDCP count as a function of an uplink hyper frame number (HFN) and the last uplink PDCP SN (e.g., uplink PDCP count=[uplink HFN, last uplink PDCP SN]), and a downlink PDCP count as a function of a downlink HFN and the last downlink PDCP SN (e.g., downlink PDCP count=[downlink HFN, last downlink PDCP SN]). Also, for each DRB associated with each device (e.g., device 110), the standby CU-UP 124, employing the state component 310, can determine and/or set user plane protocol (e.g., PDCP) state variables, comprising the next transmission value (TX_NEXT), the next reception value (RX_NEXT), the reception delivery value (RX_DELIV), and the reception reorder value (RX_REORD), as TX_NEXT=downlink PDCP count+1, RX_NEXT=uplink PDCP count+1, RX_DELIV=RX_NEXT, and RX_REORD=RX_NEXT, respectively. As disclosed, TX_NEXT can be a state variable that can indicate the count value of the next PDCP SDU that is to be transmitted; RX_NEXT can be a state variable that can indicate the count value of the next PDCP SDU that is expected to be received; RX_DELIV can be a state variable that can indicate the count value of the first PDCP SDU that has not been delivered to the upper network layers, but is still being waited for; and RX_REORD can be a state variable that can indicate the count value following the count value associated with the PDCP data PDU that triggered a reordering timer (e.g., t-reordering timer). In certain embodiments, the standby CU-UP 124, employing the state component 310, also can synchronize or set other parameters, such as the first active CU-UP configuration parameter values, the device configuration parameter values of the device, and/or other parameter values, associated with the first active CU-UP 122 and the device (e.g., device 110), with regard to each DRB and each device. Such synchronizing of the user plane protocol state parameter values, CU-UP configuration parameter values, device configuration parameter values, and/or other parameters between the failed first active CU-UP122 and the standby CU-UP 124 can enable the standby CU-UP 124 to desirably restore the CU-UP state machine to ensure and achieve desirable service continuity for the one or more devices (e.g., device 110), which were being served by the failed first active CU-UP 122 and which can now be served by the standby CU-UP 124 (e.g., as the second active CU-UP 124). After the standby CU-UP determines, generates, and/or sets the various user plane protocol state parameter values and/or other parameter values, the standby CU-UP 124 can communicate a synchronization update message (e.g., communicate a status update response message) to the CU-CP 120 (e.g., to the node manager component 126 of the CU-CP 120) to inform the CU-CP 120 about the updating and/or synchronizing of the various state parameters (e.g., uplink PDCP count, downlink PDCP count, next transmission value (TX_NEXT), next reception value (RX_NEXT), reception delivery value (RX_DELIV), reception reorder value (RX_REORD), and/or other parameter values) of the standby CU-UP 124, with regard to each DRB associated with each device (e.g., device 110).

In some embodiments, in connection with (e.g., concurrently, or in parallel with) the standby CU-UP 124 updating and/or synchronizing the various state parameters to synchronize with the operational state of the failed first active CU-UP 122, the CU-CP 120 and other network components can perform various other operations to facilitate transitioning the standby CU-UP 124 over to becoming the second active CU-UP 124 that can serve the one or more devices, including the device 110. For instance, as indicated at reference numeral 514 of the CU-UP synchronization and transition process flow 500, the CU-CP 120, employing the reconfiguration component 208, can inform, instruct, or request the RAN SMO 408 that the SMO 406 is to reconfigure the transport network 302 (e.g., reconfigure network equipment of the transport network 302) to switch a downlink data path (and associated downlink data from the UPF 304), and switch an uplink data path (and associated uplink data from the DU (e.g., DU 114)), from the first active CU-UP 122 to the standby CU-UP 124, with regard to each DU (e.g., DU 114) associated with each device (e.g., device 110) that was being served by the first active CU-UP 122. In response, with regard to each DU (e.g., DU 114) associated with each device (e.g., device 110) that was being served by the first active CU-UP 122, the RAN SMO 408 can reconfigure the transport network 302 (e.g., reconfigure network equipment of the transport network 302) to switch the uplink data path (and associated uplink data from the DU (e.g., DU 114)) from the first active CU-UP 122 to the standby CU-UP 124, as indicated at reference numeral 516 of the CU-UP synchronization and transition process flow 500. With regard to each device (e.g., device 110) that had been served by the first active CU-UP 122 and each DU (e.g., 114) associated therewith, after the switching of the uplink data path, the standby CU-UP 124 can begin receiving uplink data associated with each device (e.g., device 110) of the one or more devices from each DU (e.g., DU 114) of the one or more DUs, and storing the uplink data in a buffer component 312 (e.g., buffer memory), as indicated at reference numerals 518 and 520, respectively, of the CU-UP synchronization and transition process flow 500.

Also, in response to the informing, instructing, or requesting that the transport network 302 be reconfigured, with regard to each DU (e.g., DU 114) associated with each device (e.g., device 110) that was being served by the first active CU-UP 122, the RAN SMO 408 can inform, instruct, or request that the E2E SMO 410 reconfigure the transport network 302 to switch the downlink data path (and associated downlink data from the UPF 304) from the first active CU-UP 122 to the standby CU-UP 124, as indicated at reference numeral 522 of the CU-UP synchronization and transition process flow 500. In response, with regard to each device (e.g., device 110) that was being served by the first active CU-UP 122, the E2E SMO 410 can reconfigure the transport network 302 to switch the downlink data path (and associated downlink data from the UPF 304) from the first active CU-UP 122 to the standby CU-UP 124, as indicated at reference numeral 524 of the CU-UP synchronization and transition process flow 500. With regard to each device (e.g., device 110) that had been served by the first active CU-UP 122, after the switching of the downlink data path to the standby CU-UP 124, the standby CU-UP 124 can begin receiving downlink data associated with each device (e.g., device 110) of the one or more devices from the UPF 304, and storing the downlink data in the buffer component 312, as indicated at reference numerals 526 and 528, respectively, of the CU-UP synchronization and transition process flow 500.

As indicated at reference numeral 530 of the CU-UP synchronization and transition process flow 500, the synchronization of the standby CU-UP 124 with the failed first active CU-UP 122 can be determined to be completed. As indicated at reference numeral 532, the standby CU-UP 124, as the second active CU-UP 124 with respect to each device (e.g., device 110) of the one or more devices and the one or more DRBs respectively associated therewith, can continue to receive the downlink data from the UPF 304. Given that the synchronization is complete, with regard to each device (e.g., device 110) of the one or more devices and the one or more DRBs respectively associated therewith, the second active CU-UP 124 can communicate the downlink data, including the buffered downlink data that was stored in the buffer component 312, to each DU (e.g., DU 114) of the one or more DUs, as indicated at reference numeral 534. The one or more DUs can forward (e.g., communicate) the respective downlink data to each of the one or more devices (e.g., device 110) via the one or more DRBs.

Also, with regard to each device (e.g., device 110) of the one or more devices and the one or more DRBs respectively associated therewith, the second active CU-UP 124 can continue to receive uplink data from the one or more DUs (e.g., DU 114) associated with the one or more devices and the one or more DRBs, as indicated at reference numeral 536. As indicated at reference numeral 538, the second active CU-UP 124 can communicate the uplink data, including the buffered uplink data that was stored in the buffer component 312, to the UPF 304. The UPF 304 can forward (e.g., communicate) the respective uplink data associated with the respective one or more devices (e.g., device 110) to the desired respective destinations (e.g., the device 112, or other destination device, node, and/or service).

With further regard to the first active CU-UP 122, it is to be appreciated and understood that, in some embodiments, similar to the second active CU-UP 124 (formerly the standby CU-UP), the first active CU-UP 122 can comprise a state component 306 and a buffer component 308 that can comprise the same or similar respective functionality of the state component 310 and the buffer component 312 of the second active CU-UP 124.

Referring again to FIG. 6 (along with FIGS. 1-5), in certain embodiments, the CU-CP 120, employing the synchronizer component 206, can perform the portion of the non-limiting CU-UP synchronization and transition process flow 600 to synchronize the user plane protocol state parameter values and/or other parameter values using F1AP and E1AP signaling. For instance, as indicated at reference numeral 602, with regard to each DU (e.g., DU 114) of the one or more DUs, and with regard to each DRB or the one or more DRBs associated with each device (e.g., device 110) of the one or more devices, associated with the failed first active CU-UP 122, the synchronizer component 206 can generate a status request message, such as, for example, an F1AP status request message, and can communicate the status request message to the DU to request that the DU provide, for each DRB associated with the device (e.g., device 110) and the first active CU-UP 122, the last downlink PDCP SN received from the first active CU-UP 122 and the last uplink PDCP SN sent to the first active CU-UP 122. The request can include all of the one or more DRBs associated with (e.g., belonging to) the device (e.g., device 110).

As indicated at reference numeral 604, each DU (e.g., DU 114) of the one or more DUs, employing the device parameter component (e.g., device parameter component 314), can generate a status response message, such as, for example, an F1AP status response message, and can communicate the status response message to the synchronizer component 206. The status response message can comprise those requested parameter values (e.g., the last downlink PDCP SN received from the first active CU-UP 122 and the last uplink PDCP SN sent to the first active CU-UP 122) and/or other desired information (e.g., other parameter values usable for the synchronization).

As indicated at reference numeral 606, with regard to each DRB or the one or more DRBs associated with each device (e.g., device 110) of the one or more devices, associated with the failed first active CU-UP 122, the synchronizer component 206 can generate a status update request message, such as, for example, an E1AP status update request message, and can communicate the status update request message to the standby CU-UP 124 to request that the standby CU-UP 128 update its status (e.g., as part of synchronizing with the first active CU-UP 122). The status update request message can comprise the last downlink PDCP SN received from the first active CU-UP and the last uplink PDCP SN sent to the first active CU-UP, with regard to each DRB associated with the device (e.g., device 110).

As indicated at reference numeral 608, in response to receiving the status update request message, with regard to each DRB of the one or more DRBs associated with each device (e.g., device 110) of the one or more devices, the standby CU-UP 124, employing the state component 310, can determine, generate, and/or set various user plane protocol state parameter values, based at least in part on the last downlink PDCP SN and the last uplink PDCP SN. For instance, for each DRB associated with each device (e.g., device 110) and present in the status update request message, the standby CU-UP 124, employing the state component 310, can determine and/or generate the uplink PDCP count based at least in part on (e.g., as a function of) the uplink HFN and the last uplink PDCP SN (e.g., uplink PDCP count=[uplink HFN, last uplink PDCP SN]), and the downlink PDCP count based at least in part on (e.g., as a function of) the downlink HFN and the last downlink PDCP SN (e.g., downlink PDCP count=[downlink HFN, last downlink PDCP SN]). Also, for each DRB associated with each device (e.g., device 110) and present in the status update request message, the standby CU-UP 124, employing the state component 310, can determine and/or set the PDCP state variables, such as the next transmission value (TX_NEXT), the next reception value (RX_NEXT), the reception delivery value (RX_DELIV), and the reception reorder value (RX_REORD), as TX_NEXT=downlink PDCP count+1, RX_NEXT=uplink PDCP count+1, RX_DELIV=RX_NEXT, and RX_REORD=RX_NEXT, respectively.

After the standby CU-UP determines, generates, and/or sets the various user plane protocol state parameter values, as indicated at reference numeral 610, with regard to each DRB of the one or more DRBs associated with each device (e.g., device 110) of the one or more devices, the standby CU-UP 124 can generate a status update response message, such as, for example, an E1AP status update response message, and can communicate the status update response message to the CU-CP 120 (e.g., to the node manager component 126 of the CU-CP 120) to inform the CU-CP 120 about updating and/or synchronizing of the status of the standby CU-UP 124, including the updating and/or synchronizing of the uplink PDCP count and downlink PDCP count, with regard to each DRB associated with each device (e.g., device 110).

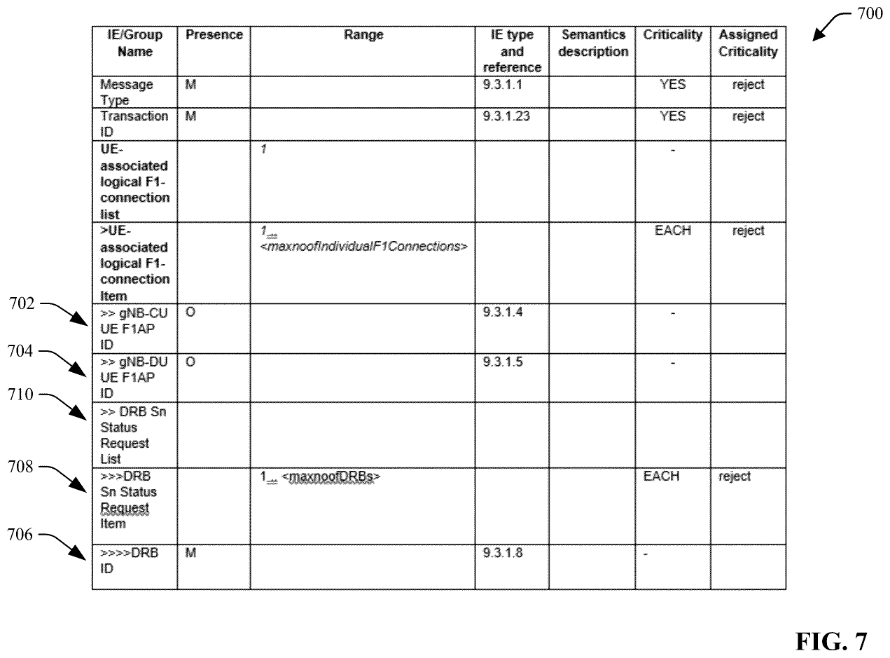

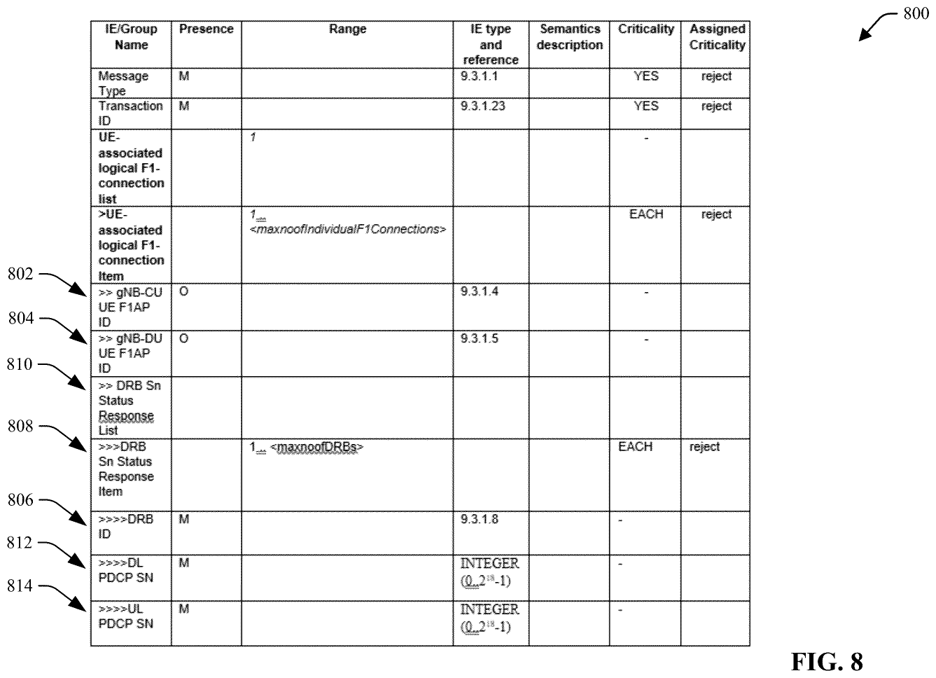

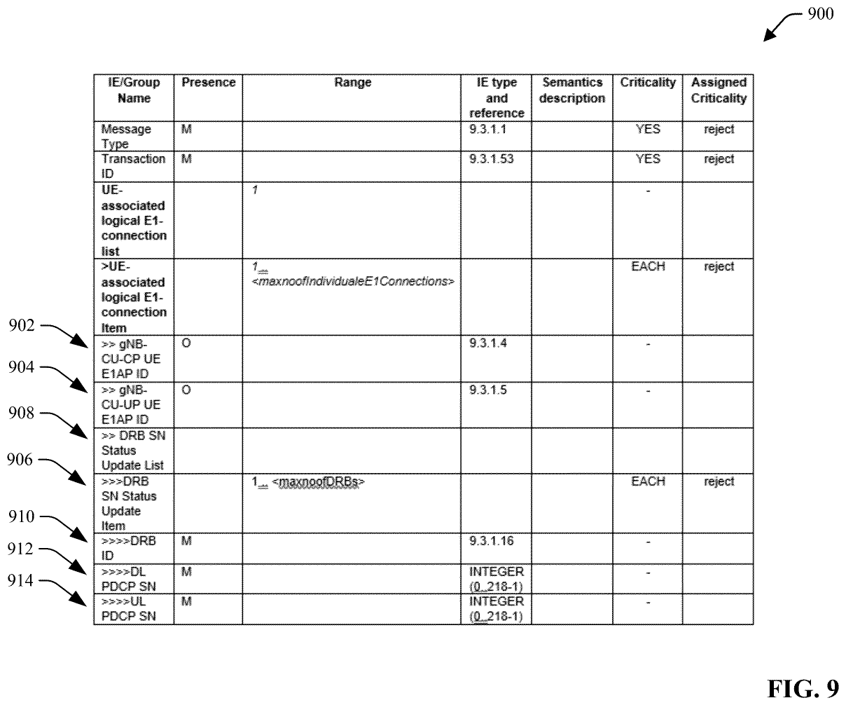

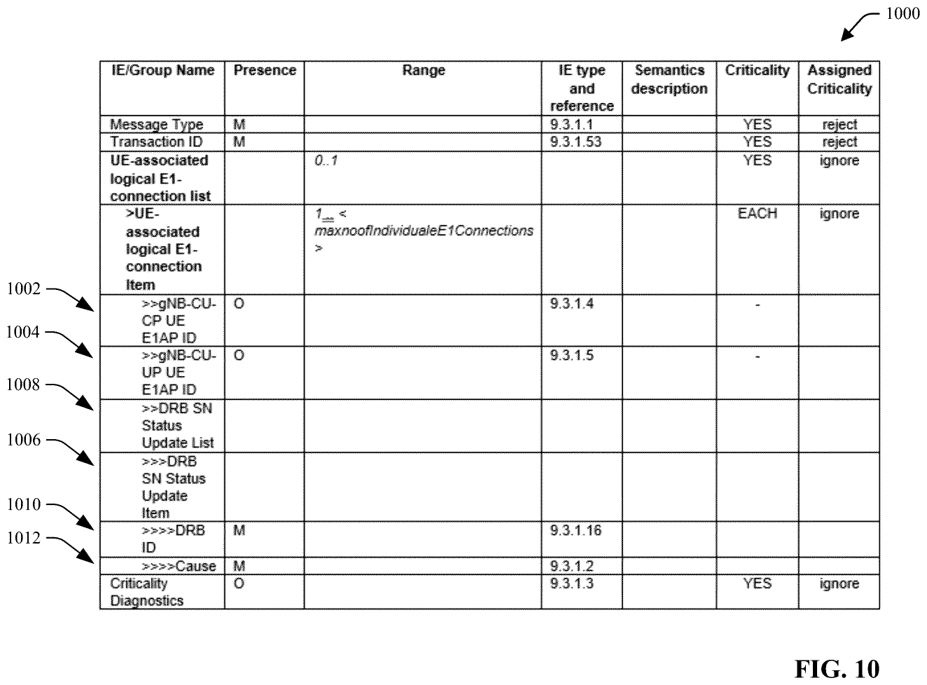

Referring to FIGS. 7-10 (along with FIGS. 1-6), FIG. 7 presents a diagram of a non-limiting example status request message 700, FIG. 8 presents a diagram of a non-limiting example status response message 800, FIG. 9 presents a diagram of a non-limiting example status update request message 900, and FIG. 10 presents a diagram of a non-limiting example status update response message 1000, in accordance with various aspects and embodiments of the disclosed subject matter. The status request message 700 depicted in FIG. 7 is an example message (e.g., F1AP status request message) that the CU-CP 120 can communicate to each DU (e.g., DU 114) associated with a device (e.g., device 110) associated with the failed first active CU-UP 122. The status request message 700 can request that the DU (e.g., DU 114) provide, for each DRB associated with the device (e.g., device 110) and the first active CU-UP 122, SN status information comprising the last downlink PDCP SN received from the first active CU-UP 122 and the last uplink PDCP SN sent to the first active CU-UP 122. In that regard, the status request message 700 can comprise various fields. Such fields of the status request message 700 can comprise a CU identifier (ID) field 702 (e.g., gNB-CU UE F1AP ID) that can comprise CU identifier information that can identify the CU (e.g., CU-CP 120 and/or the first active CU-UP 122) requesting certain state parameters (e.g., the last downlink PDCP SN received from the first active CU-UP 122 and the last uplink PDCP SN sent to the first active CU-UP 122) and/or associated with the requested state parameters. Such fields of the status request message 700 also can comprise a DU ID field 704 (e.g., gNB-DU UE F1AP ID) that can comprise DU identifier information that can identify the DU (e.g., DU 114) associated with the device (e.g., device 110) and DRB(s) associated with the failed first active CU-UP 122. Such fields of the status request message 700 further can comprise a DRB ID field 706 that can comprise DRB identifier information that can identify each DRB associated with the device (e.g., device 110). Such fields of the status request message 700 further can comprise an SN status request item field 708 (e.g., DRB SN status request item) that can comprise SN status request item information that can indicate the message 700 is a request for certain SN status information, and an SN status request list field 710 (e.g., DRB SN status request list) that can comprise SN status request list information that can identify or indicate the parameter information (e.g., the last downlink PDCP SN received from the first active CU-UP 122, the last uplink PDCP SN sent to the first active CU-UP 122, and/or another desired parameter) requested with regard to each DRB associated with the device (e.g., device 110).

With regard to the status response message 800 of FIG. 8, the status response message 800 can be an example message (e.g., F1AP status response message) that the DU (e.g., DU 114) can communicate to the CU-CP 120 in response to the status request message (e.g., status request message 700). The status response message 800 can provide the current SN status associated with the DU (e.g., DU 114) and the failed first active CU-UP 122 with regard to the device(s) (e.g., device 110) and associated DRB(s), wherein the current SN status can comprise the last downlink PDCP SN received from the first active CU-UP 122 and the last uplink PDCP SN sent to the first active CU-UP 122.

In that regard, the status response message 800 can comprise various information fields. Such information fields of the status response message 800 can comprise the CU ID field 802, the DU ID field 804, and the DRB ID field 806 that can be the same as or similar to the corresponding information fields of the status request message 700. The status response message 800 also can comprise an SN status response item field 808 (e.g., DRB SN status response item) that can comprise SN status response item information that can indicate the message 800 is a response that can provide certain current SN status information (e.g., in response to the status request message 700), and the SN status response list field 810 (e.g., DRB SN status response list) that can comprise SN status response list information that can identify or indicate the parameter information (e.g., the last downlink PDCP SN received from the first active CU-UP 122, the last uplink PDCP SN sent to the first active CU-UP 122, and/or another desired parameter) being provided (e.g., in response to the request) with regard to each DRB associated with the device (e.g., device 110). The status response message 800 also can comprise a downlink PDCP SN field 812 that can comprise the last downlink PDCP SN received from the first active CU-UP 122 with regard to the DRB (e.g., the DRB identified in the DRB ID field 806). The status response message 800 further can comprise an uplink PDCP SN field 814 that can comprise the last uplink PDCP SN sent to the first active CU-UP 122 with regard to the DRB (e.g., the DRB identified in the DRB ID field 806).

Regarding the status update request message 900 depicted in FIG. 9, the status update request message 900 can be an example message (e.g., E1AP status update request message) that the CU-CP 120 can communicate to the standby CU-UP 124 to request that the standby CU-UP 124 update the PDCP counts to facilitate synchronizing the state (e.g., operational state, such as state parameters) of the standby CU-UP 124 with the state of the failed first active CU-UP 122. The status update request message 900 can comprise various information fields. For instance, the status update request message 900 can comprise a CU-CP ID field 902 (e.g., gNB-CU-CP UE E1AP ID) that can comprise CU-CP identifier information that can identify the CU-CP (e.g., CU-CP 120) requesting the standby CU-UP 124 perform the status update. The status update request message 900 also can comprise a CU-UP ID field 904 (e.g., gNB-CU-UP UE E1AP ID) that can comprise CU-UP identifier information that can identify the CU-UP (e.g., standby CU-UP 124) to which the status update request is directed. The status update request message 900 further can include an SN status update item field 906 (e.g., DRB SN status update item) that can indicate an SN status update with regard to the DRB (e.g., for each DRB associated with the device 110) is requested. The status update request message 900 also can comprise an SN status update list field 908 (e.g., DRB SN status request list) that can comprise SN status update list information that can identify or indicate that certain state parameter information, as identified or provided in the status update request message 900, with regard to the DRB (e.g., for each DRB associated with the device 110), is to be updated by the standby CU-UP 124. The status update request message 900 further can comprise a DRB ID field 910 that can comprise DRB identifier information that can identify the DRB (e.g., with regard to each DRB) associated with the device (e.g., device 110) for which the state parameter information is to be updated. The status update request message 900 also can comprise a downlink PDCP SN field 912 that can comprise the last downlink PDCP SN received from the first active CU-UP 122 with regard to the DRB (e.g., the DRB identified in the DRB ID field 910). The status update request message 900 further can comprise an uplink PDCP SN field 914 that can comprise the last uplink PDCP SN sent to the first active CU-UP 122 with regard to the DRB (e.g., the DRB identified in the DRB ID field 910).

With regard to the status update response message 1000 depicted in FIG. 10, the status update response message 1000 can be an example message (e.g., E1AP SN status update response message) that the standby CU-UP 124 can communicate to the CU-CP 120 in response to the status update request message (e.g., status update request message 900) after updating the state parameter information, as requested. The status update response message 1000 can comprise information that can indicate whether the state parameter update (e.g., PDCP count update) for the requested DRB was successfully performed or not. The status update response message 1000 can comprise various fields. For instance, the status update response message 1000 can comprise a CU-CP ID field 1002 (e.g., gNB-CU-CP UE E1AP ID) that can comprise CU-CP identifier information that can identify the CU-CP (e.g., CU-CP 120) to which the status update response message 1000 is directed, and from which the status request message was received. The status update response message 1000 also can comprise a CU-UP ID field 1004 (e.g., gNB-CU-UP UE E1AP ID) that can comprise CU-UP identifier information that can identify the CU-UP (e.g., standby CU-UP 124) providing the status update response message 1000. The status update response message 1000 further can include an SN status update item field 1006 (e.g., DRB SN status update item) that can indicate the SN status update with regard to the DRB (e.g., for each DRB associated with the device 110) that was performed, or at least was supposed to be performed. The status update response message 1000 also can comprise an SN status update list field 1008 (e.g., DRB SN status request list) that can comprise SN status update list information that can identify or indicate certain state parameter information, with regard to the DRB (e.g., for each DRB associated with the device 110), that was updated, or at least was supposed to be updated, by the standby CU-UP 124. The status update response message 1000 further can comprise a DRB ID field 1010 that can comprise DRB identifier information that can identify the DRB (e.g., with regard to each DRB) associated with the device (e.g., device 110) for which the state parameter information was updated, or at least was supposed to be updated. The status update response message 1000 also can comprise a cause field 1012 that can comprise cause or update information that can indicate whether the state parameter update (e.g., PDCP count update) for the requested DRB was successfully performed or not.

It is to be appreciated and understood that the example messages of FIGS. 7-10 are non-limiting example messages, and, in other embodiments, the disclosed subject matter (e.g., the CU-CP 120 and the DU 114) can employ different types of messages and/or can utilize different types of message formats and fields to request or exchange information (e.g., user plane protocol state parameter values and/or other parameter values) to facilitate synchronizing the standby CU-UP 124 with the first active CU-UP 122, in accordance with the techniques disclosed herein.

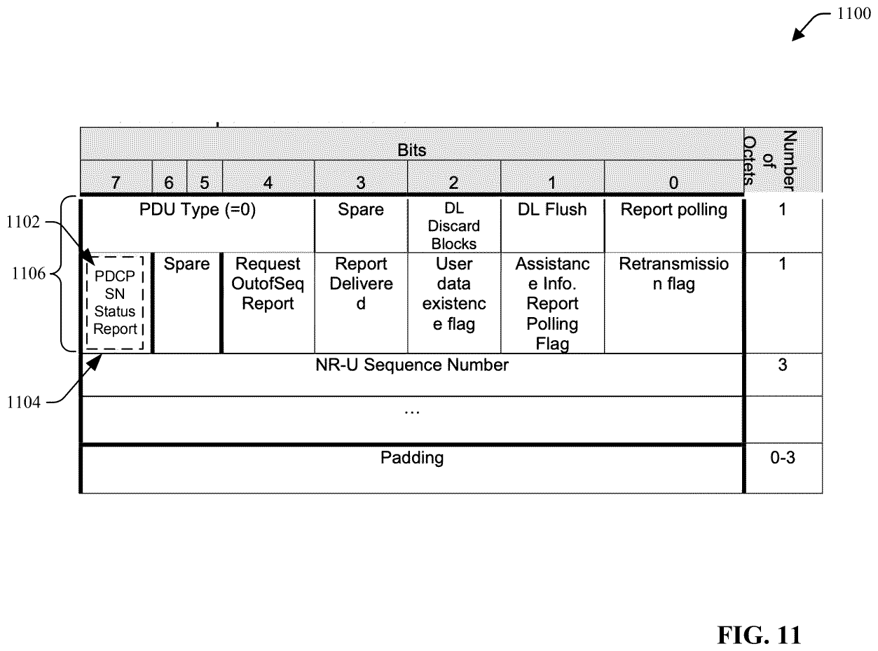

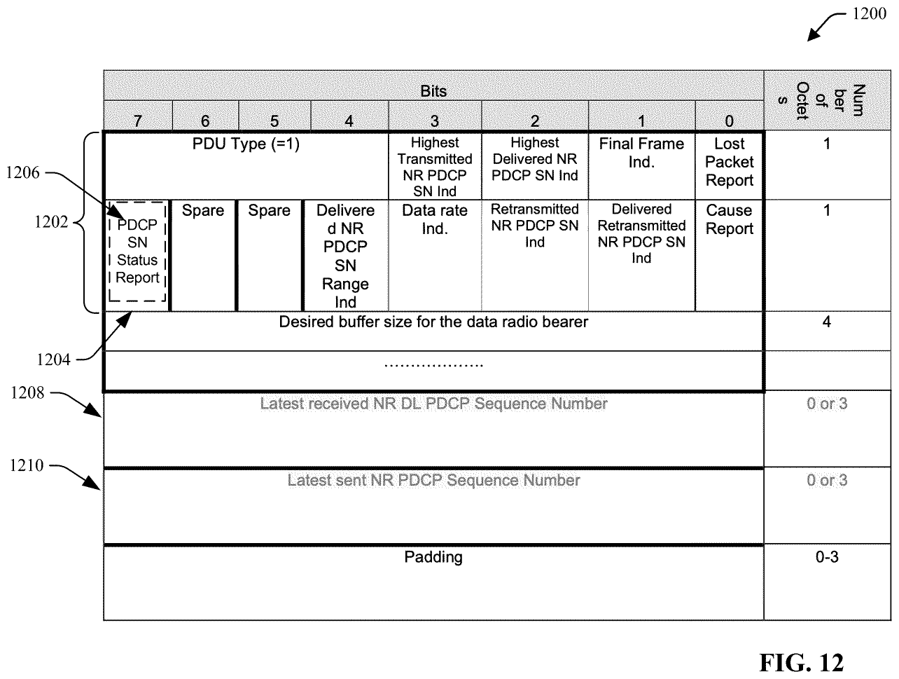

In certain other embodiments, as part of the synchronizing process to synchronize the standby CU-UP 124 with the failed first active CU-UP 122, the synchronizer component 206 can synchronize the user plane protocol state parameter values and/or other parameter values using the NR-UP process. In that regard, referring to FIGS. 11 and 12, FIG. 11 depicts a diagram of a non-limiting example NR-UP downlink user data (NR-UP DUD) packet 1100 that can comprise a PDCP SN status report indicator 1102 that can be sent to the DU (e.g., DU 114) to request a PDCP SN status report be provided, and FIG. 12 depicts a diagram of a non-limiting example NR-UP downlink data delivery status (NR-UP DDDS) packet 1200 that can comprise a PDCP SN status report, comprising the desired user plane protocol state parameter values (e.g., PDCP SN values) and/or other parameter values, that can be sent by the DU (e.g., DU 114) to the CU-CP 120, in accordance with various aspects and embodiments of the disclosed subject matter.

With regard to the NR-UP DUD packet 1100 depicted in FIG. 11, the synchronizer component 206 can generate the NR-UP DUD packet 1100 that can comprise the PDCP SN status report indicator 1102 in a bit(s), which can be a PDCP SN status report indicator field 1104, of the header section 1106 of the NR-UP DUD packet 1100. In some embodiments, the bit(s) utilized for the PDCP SN status report indicator field 1104 can be a spare bit(s) of the header section 1106 that can be available for use. If the PDCP SN status report indicator 1102 has a first value (e.g., a 1 value, or other desired value), the first value can indicate that a PDCP SN status report is requested from the DU (e.g., DU 114) receiving the NR-UP DUD packet 1100. If the PDCP SN status report indicator 1102 has a second value (e.g., a 0 value, or other desired value that can be different from the first value), the second value can indicate that no PDCP SN status report is requested from the DU (e.g., DU 114) receiving the NR-UP DUD packet 1100. When the NR-UP DUD packet 1100 is generated with the PDCP SN status report indicator 1102 set to the first value to request that the DU (e.g., DU 114) provide the PDCP SN status report, such request for the PDCP SN status report can request that the DU provide desired (e.g., requested or wanted) user plane protocol state parameter values (e.g., PDCP SN values, such as the last downlink PDCP SN received from the first active CU-UP 122 and the last uplink PDCP SN sent to the first active CU-UP 122) and/or other parameter values with regard to each DRB, of the one or more DRBs, associated with each device (e.g., device 110) of the one or more devices associated with the failed first active CU-UP 122.

When the DU (e.g., 114) receives the NR-UP DUD packet 1100, and the PDCP SN status report indicator 1102 has the first value indicating that a PDCP SN status report is requested from the DU, the DU can determine the desired (e.g., requested or wanted) user plane protocol state parameter values (e.g., PDCP SN values) and/or other parameter values with regard to each DRB, of the one or more DRBs, associated with each device (e.g., device 110) of the one or more devices associated with the failed first active CU-UP 122. With regard to the NR-UP DDDS packet 1200 depicted in FIG. 12, the DU (e.g., 114) can generate the NR-UP DDDS packet 1200 comprising the desired user plane protocol state parameter values and/or other parameter values with regard to each DRB, of the one or more DRBs, associated with each device (e.g., device 110) of the one or more devices associated with the failed first active CU-UP 122.

For instance, the NR-UP DDDS packet 1200 can comprise a header section 1202 that can comprise a PDCP SN status report field 1204 that can comprise a PDCP SN status report indicator 1206 that can indicate whether a PDCP SN status report is included or not in the NR-UP DDDS packet 1200. If the PDCP SN status report indicator 1206 has a first value (e.g., a 1 value, or other desired value), the first value can indicate that the NR-UP DDDS packet 1200 contains the PDCP SN status report. If the PDCP SN status report indicator 1206 has a second value (e.g., a 0 value, or other desired value that can be different from the first value), the second value can indicate that no PDCP SN status report is included in the NR-UP DDDS packet 1200 and/or that the update was not, or was not able to be, performed by the DU (e.g., DU 114). If the NR-UP DDDS packet 1200 comprises the PDCP SN status report, the NR-UP DDDS packet 1200 can comprise a first PDCP SN field 1208 that can comprise the latest received NR DL PDCP sequence number, which can be the PDCP SN of the last downlink PDCP PDU received from the first active CU-UP 122 with regard to the DRB (e.g., for each DRB) associated with the device (e.g., device 110), for each device, associated with the first active CU-UP 122, and a second PDCP SN field 1210 that can comprise the latest sent NR PDCP sequence number, which can be the PDCP SN of the last uplink PDCP PDU sent to the first active CU-UP 122 with regard to the DRB (e.g., for each DRB) associated with the device (e.g., device 110), for each device, associated with the first active CU-UP 122.

The DU (e.g., DU 114) can communicate the NR-UP DDDS packet 1200 to the CU-CP 120. Based at least in part on the results of analyzing the information, including the PDCP SN status report, in the NR-UP DDDS packet 1200, the CU-CP 120, employing the synchronizer component 206, can determine or identify the desired user plane protocol state parameter values (e.g., PDCP SN values, such as the last downlink PDCP SN received from the first active CU-UP 122 and the last uplink PDCP SN sent to the first active CU-UP 122) and/or other parameter values with regard to each DRB, of the one or more DRBs, associated with each device (e.g., device 110) of the one or more devices associated with the failed first active CU-UP 122. The CU-CP 120 can provide (e.g., communicate) the desired user plane protocol state parameter values and/or other parameter values to the standby CU-UP 124 for the standby CU-UP 124 to use to update its status and synchronize with the first active CU-UP 122, such as described herein.

It is to be appreciated and understood that the example packets (e.g., the NR-UP DUD packet 1100 and the NR-UP DDDS packet 1200) of FIGS. 11 and 12 are non-limiting example packets, and the disclosed subject matter (e.g., the CU-CP 120 and the DU 114) can employ different types of packets and/or can utilize different types of packet formats and fields to request or exchange information (e.g., user plane protocol state parameter values and/or other parameter values) to facilitate synchronizing the standby CU-UP 124 with the first active CU-UP 122, in accordance with the techniques disclosed herein.

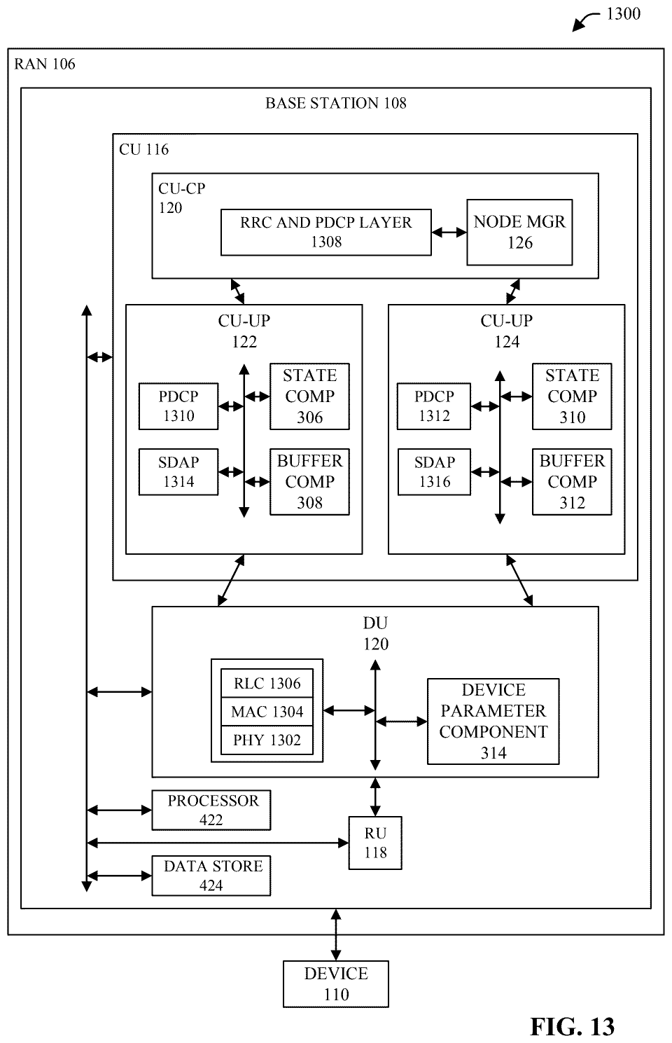

Turning to FIG. 13 (along with FIGS. 1 and 2), FIG. 13 illustrates a block diagram of non-limiting example system 1300 that can comprise the RAN 106, which can comprise the node manager component 126 (e.g., in or associated with the CU-CP 120) that can desirably perform and manage CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter. In some embodiments, the system 1300 can be part of the system 100 depicted in FIG. 1, the system 300 of FIG. 3, and/or the system 400 depicted in FIG. 4. The RAN 106 can comprise the base station 108 that can comprise the DU 114, the CU 116, and the RU 118. The CU 116 can comprise the CU-CP 120 and the CU-UPs 122 and 124. The CU-CP 120 can comprise or be associated with the node manager component 126 that can perform various operations and functions, such as more fully described herein.

In some embodiments, the RAN 106 can be an O-RAN that can be part of an O-RAN architecture and environment (e.g., the communication network 102 can employ an O-RAN architecture and environment). In certain embodiments, the RAN 106 can be a cloud-based or centralized RAN (C-RAN) that can be part of a cloud or centralized RAN (C-RAN) architecture and environment, or a virtual RAN (vRAN) that can be part of a vRAN architecture and environment (e.g., the communication network 102 can employ a C-RAN or vRAN architecture and environment). In still other embodiments, the RAN 106 may not be an O-RAN, C-RAN, or vRAN.

The DU 114 can be a logical node that can host or handle baseband (e.g., PHY 1302) and layer 2 (L2) (e.g., MAC layer 1304 and RLC layer 1306) functionality associated with the base station. The DU 114 can comprise the device parameter component 314, such as described herein.

The CU-CP 120 (also referred to as a CU-CP node) can be a logical node that can host or handle layer 3 (L3) (e.g., radio resource control (RRC) and PDCP layer 1308) control plane functionality associated with the base station 108. The CU-UPs 122 and 124 (also referred to as a CU-UP nodes) can be logical nodes that can host or handle data traffic between the core network 104 (e.g., 5G core network) and the DUs (e.g., 114) to which the CU-UPs 122 and 124 are connected. The CU-UPs 122 and 124 can comprise respective state components 306 and 310, and respective buffer components 308 and 312, that can respectively operate and perform respective functions, such as described herein. In some embodiments, the CU-UPs 122 and 124 can comprise respective PDCP components 1310 and 1312 that can perform PDCP functions, and respective SDAP components (SDAP) 1314 and 1316 that can perform SDAP functions. The RU 118 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 106 and other devices (e.g., devices 110 and/or 112) or components (e.g., components or functions of the core network 104 or communication network 102).

In certain embodiments, as disclosed, the system 1300 can comprise an O-RAN architecture and environment, and the RAN 106 can be an O-RAN. In some embodiments, in the O-RAN architecture and environment, the system 1300 also can comprise an SMO component and RIC (not shown in FIG. 13), wherein the SMO component can be associated with (e.g., communicatively connected to) the RIC and/or the RAN 106 (and/or one or more other RANs) via an interface(s) (e.g., an O1 interface, an A1 interface, or another interface), to facilitate communication of information between the SMO component and the RIC and/or the RAN 106 (and/or one or more other RANs), and the RIC can be associated with the RAN 106 (and/or one or more other RANs) via an interface(s) (e.g., an E2 interface or another interface), to facilitate communication of information between the RIC and the RAN 106 (and/or one or more other RANs).

The SMO component can act and operate as a management and orchestration layer that can control configuration and automation aspects of the RIC and RAN elements of the RAN(s). The SMO component can comprise various types of management services and various network functions, comprising network management functions, which can include RAN-type or RAN-related functions, core management functions, transport management functions, network slice management functions (e.g., end-to-end (E2E) network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time. The RIC can operate to control (e.g., manage) and enhance (e.g., improve or optimize) RAN functions and services of the RAN(s). At least some of the various network functions and components of the RIC can operate in real time or near real time, and some network functions and components of the RIC may operate in non-real time.

In accordance with various embodiments, the RAN 106 can comprise a processor component 1318 that can be associated with (e.g., communicatively connected to) and can work in conjunction with other components of the RAN 106, including the base station(s) (e.g., 108), the DU(s) (e.g., 114), the CU 116, the RU(s) 118, the node manager component 126, a data store 1320, and/or other components of the RAN 106, to facilitate performing the various functions and operations of the RAN 106. The processor component 1318 can employ one or more processors (e.g., one or more central processing units (CPUs)), microprocessors, or controllers that can process information relating to data, files, services, applications, communication networks, RANs, cells, devices, resources, user plane protocol state parameters, CU-UP configuration parameters, device configuration parameters, PDU session data, CU-UP failure indicators or information, threshold values or levels (e.g., threshold value indicating failure of a CU-UP), data processing operations, messages, notifications, alarms, alerts, preferences (e.g., user or client preferences), hash values, metadata, parameters, traffic flows, policies, the defined node management criteria, algorithms (e.g., enhanced node management algorithms, enhanced CU-UP synchronization algorithms, enhanced CU-UP transition algorithms, hash algorithms, data compression algorithms, data decompression algorithms, and/or other algorithm), interfaces, protocols, tools, and/or other information, to facilitate operation of the RAN 106, and control data flow between the RAN 106 and/or other components (e.g., network components, another RAN, the communication network 102, a device (e.g., 110 or 112), a node, a service, a user, or other entity) associated with the RAN 106.

The data store 1320 can store data structures (e.g., user data, metadata), code structure(s) (e.g., modules, objects, hashes, classes, procedures) or instructions, information relating to data, files, services, applications, communication networks, RANs, cells, devices, resources, user plane protocol state parameters, CU-UP configuration parameters, device configuration parameters, PDU session data, CU-UP failure indicators or information, threshold values or levels (e.g., threshold value indicating failure of a CU-UP), data processing operations, messages, notifications, alarms, alerts, preferences (e.g., user or client preferences), hash values, metadata, parameters, traffic flows, policies, the defined node management criteria, algorithms (e.g., enhanced node management algorithms, enhanced CU-UP synchronization algorithms, enhanced CU-UP transition algorithms, hash algorithms, data compression algorithms, data decompression algorithms, and/or other algorithm), interfaces, protocols, tools, and/or other information, to facilitate controlling or performing operations associated with the RAN 106. The data store 1320 can comprise volatile and/or non-volatile memory, such as described herein. In an aspect, the processor component 1318 can be functionally coupled (e.g., through a memory bus) to the data store 1320 in order to store and retrieve information desired to operate and/or confer functionality, at least in part, to the base station(s) (e.g., 108), DU(s) (e.g., 114), CU 120, RU(s) 118, node manager component 126, processor component 1318, data store 1320, and/or other component of the RAN 106, and/or substantially any other operational aspects of RAN 106.

As disclosed, the data store 1320 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

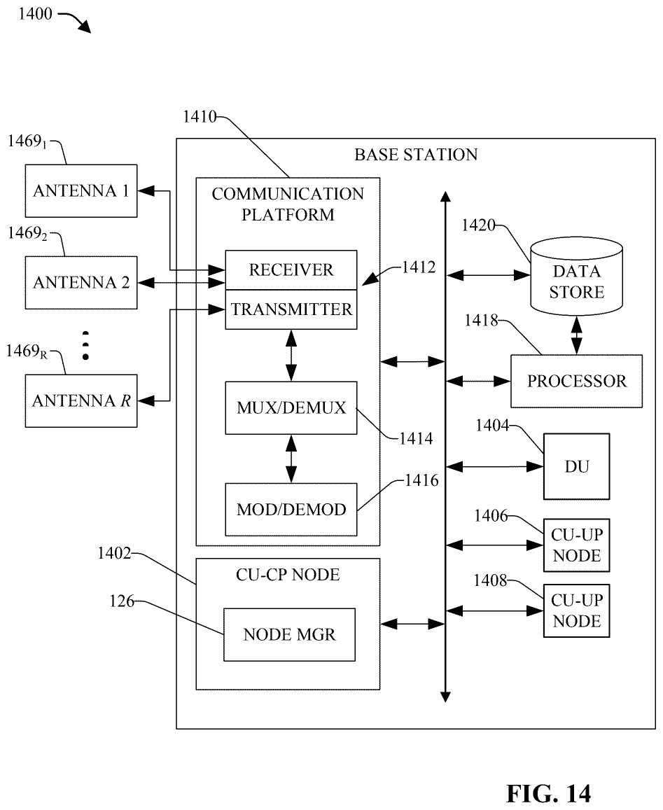

Turning to FIG. 14, FIG. 14 depicts a diagram of a non-limiting example base station 1400 that can desirably facilitate (e.g., enable) connections (e.g., wireless connections) and communication of information associated with devices, in accordance with various aspects and embodiments of the disclosed subject matter. In some embodiments, the base station 1400 can be a 5G or other NR base station (e.g., gNB or other NR-type or xG base station, wherein x can be a number greater than 5). In other embodiments, the base station 1400 can be a 4G or LTE base station, or some other type of base station (e.g., other type of access point).

With regard to a 5G or other NR base station, the base station 1400 can comprise a CU-CP node 1402 (e.g., a gNB or other NR-NB CU-CP node), one or more DUs (e.g., a gNB or other NR-NB DUs), including DU 1404, a desired number of CU-UP nodes (e.g., a gNB or other NR-NB CU-UP nodes), including CU-UP nodes 1406 and 1408, and/or other network equipment. The CU-CP node 1402 can be associated or interfaced with the DUs (e.g., DU 1404) via an interface (e.g., F1-C interface) or connection. The CU-CP node 1402 can be associated or interfaced with the CU-UP nodes (e.g., CU-UP nodes 1406 and 1408) via an interface (e.g., E1 interface) or connection. The CU-UP nodes (e.g., CU-UP nodes 1406 and 1408) can be associated or interfaced with the one or more DUs (e.g., DU 1404) via an interface (e.g., F1-U interface) or connection.

A DU (e.g., DU 1404) can provide support for lower layers of a protocol stack. For instance, a DU (e.g., DU 1404) can be a logical node that can host or handle baseband (e.g., PHY) and L2 (e.g., MAC and RLC layer) functionality associated with the base station 1400. A CU-UP node (e.g., CU-UP node 1406 and 1408) can be a logical node that can host or handle data traffic between the core network 104 (e.g., 5G or other NR or xG core network) and the DU(s) (e.g., DU 1404) to which the particular CU-UP is connected. The CU-CP node 1402 can be a logical node that can host or handle L3 (e.g., RRC and PDCP layer) control plane functionality associated with the base station 1400.

In some embodiments, a device(s) (e.g., device(s) 110 and/or 112) can be connected to the base station 1400, via the DU 1404, wherein one or more CU-UP nodes (e.g., CU-UP nodes 1406 and 1408) and the DU 1404 can be serving the device by performing or facilitating performing downlink data transfers of downlink data to the device from a data source (e.g., a service and/or another device, or a network component of the communication network 102 or core network 104 (e.g., via the UPF node)), and uplink data transfers of uplink data from the device to a desired destination (e.g., the data source) via the base station 1400.

The base station 1400 can receive and transmit signal(s) from and to wireless devices like access points (e.g., base stations, femtocells, picocells, or other type of access point), access terminals (e.g., UEs), wireless ports and routers, and the like, through a set of antennas 1469₁-1469_{R}. In an aspect, the antennas 1469₁-1469_{R} can be a part of a communication platform 1410, which can comprise electronic components and associated circuitry that can provide for processing and manipulation of received signal(s) and signal(s) to be transmitted. In an aspect, the communication platform 1410 can include a receiver/transmitter 1412 that can convert signal from analog to digital upon reception, and from digital to analog upon transmission. In addition, receiver/transmitter 1412 can divide a single data stream into multiple, parallel data streams, or perform the reciprocal operation. In accordance with various embodiments, the communication platform 1410 can be, can comprise, or can be associated with an RU(s) (e.g., a gNB or other NR-NB RU node(s)).

In an aspect, coupled to receiver/transmitter 1412 can be a multiplexer/demultiplexer (mux/demux) 1414 that can facilitate manipulation of signal in time and frequency space. The mux/demux 1414 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 1414 can scramble and spread information (e.g., codes) according to substantially any code known in the art, e.g., Hadamard-Walsh codes, Baker codes, Kasami codes, polyphase codes, and so on. A modulator/demodulator (mod/demod) 1416 also can be part of the communication platform 1410, and can modulate information according to multiple modulation techniques, such as frequency modulation, amplitude modulation (e.g., M-ary quadrature amplitude modulation (QAM), with M a positive integer), phase-shift keying (PSK), and the like.

The base station 1400 also can comprise a processor(s) 1418 that can be configured to confer and/or facilitate providing functionality, at least partially, to substantially any electronic component in or associated with the base station 1400. For instance, the processor(s) 1418 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data, and/or managing and operating DUs, CU-CP, CU-UPs, RUs, and/or other network functions, such as described herein.

In another aspect, the base station 1400 can include a data store 1420 that can store data structures; code instructions; rate coding information; information relating to measurement of radio link quality or reception of information related thereto; information relating to devices, communication conditions or performance indicators associated with devices (e.g., signal-to-interference-plus-noise ratio (SINR), reference signal received power (RSRP), reference signal received quality (RSRQ), channel quality indicator (CQI), and/or other wireless communications metrics or parameters); information relating to users, data, files, services, applications, communication networks, RANs, cells, resources, user plane protocol state parameters, CU-UP configuration parameters, device configuration parameters, PDU session data, CU-UP failure indicators or information, threshold values or levels (e.g., threshold value indicating failure of a CU-UP), data processing operations, messages, notifications, alarms, alerts, preferences (e.g., user or client preferences), hash values, metadata, parameters, traffic flows, policies, the defined node management criteria, algorithms (e.g., enhanced node management algorithms, enhanced CU-UP synchronization algorithms, enhanced CU-UP transition algorithms, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on. The processor(s) 1418 can employ one or more processors (e.g., one or more CPUs), microprocessors, or controllers) that can process information, and can be coupled to the data store 1420 in order to store and retrieve at least some of the information (e.g., information, such as algorithms, relating to multiplexing/demultiplexing or modulation/demodulation; information relating to radio link levels; information relating to users, data, files, services, applications, communication networks, RANs, cells, resources, user plane protocol state parameters, CU-UP configuration parameters, device configuration parameters, PDU session data, CU-UP failure indicators or information, threshold values or levels, data processing operations, messages, notifications, alarms, alerts, preferences (e.g., user or client preferences), hash values, metadata, parameters, traffic flows, policies, the defined node management criteria, algorithms (e.g., enhanced node management algorithms, enhanced CU-UP synchronization algorithms, enhanced CU-UP transition algorithms, hash algorithms, data compression algorithms, data decompression algorithms, and/or other algorithm), interfaces, protocols, tools, and/or other information) desired to operate and/or confer functionality to the communication platform 1410 and/or other operational components of the base station 1400. The data store 1420 can comprise volatile memory and/or nonvolatile memory, such as described herein.

In accordance with various embodiments, the base station 1400 (e.g., the CU-CP node 1402 of the base station 1400) can comprise or be associated with the node manager component 126 that can desirably (e.g., automatically, dynamically, suitably, reliably, efficiently, enhancedly, and/or optimally) perform and manage CU-UP failure mitigation, including synchronizing an active CU-UP and a standby CU-UP, and transitioning from the active CU-UP to the standby CU-UP to serve a device when the active CU-UP fails, such as described herein.

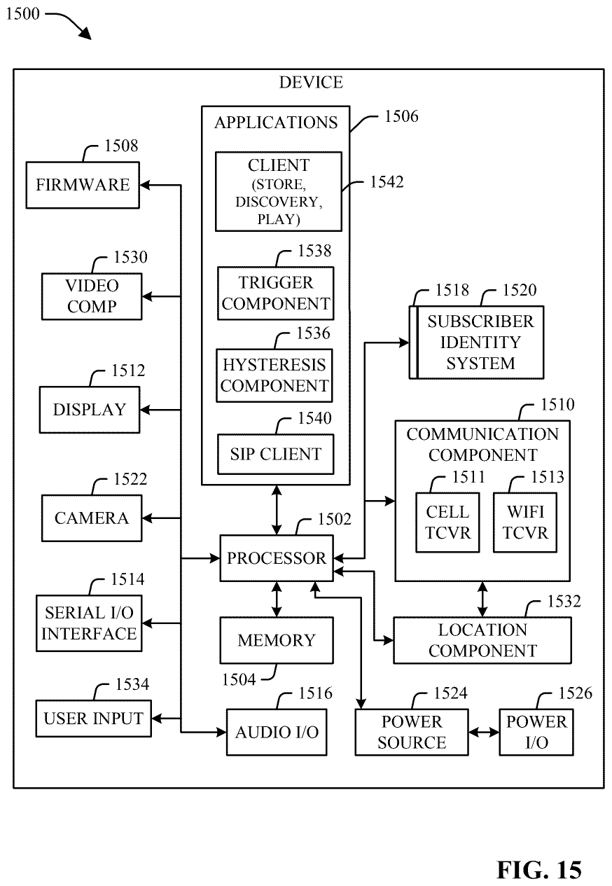

Referring to FIG. 15, FIG. 15 illustrates a diagram of a non-limiting example device 1500 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 1500 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 1500, can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 1500 can include a processor(s) 1502 for controlling and processing all onboard operations and functions. The processor(s) 1502 can comprise one or more processors (e.g., one or more central processing units (CPUs)), microprocessors, or controllers) that can process information associated with the device 1500. A memory 1504 can interface to the processor(s)1502 for storage of data and one or more applications 1506 (e.g., a video player software, user feedback component software, etc.). Other applications can include voice recognition of predetermined voice commands that facilitate initiation of the user feedback signals. The applications 1506 can be stored in the memory 1504 and/or in a firmware 1508, and executed by the processor(s) 1502 from either or both the memory 1504 or/and the firmware 1508. The firmware 1508 can also store startup code for execution in initializing the device 1500. A communication component 1510 interfaces to the processor(s) 1502 to facilitate wired/wireless communication with external systems, e.g., cellular networks, VoIP networks, and so on. Here, the communication component 1510 can also include a suitable cellular transceiver 1511 (e.g., a global system for mobile communication (GSM), orthogonal frequency division multiple access (OFDMA), 4G, LTE, 5G, other NR, or other type of transceiver) and/or an unlicensed transceiver 1513 (e.g., Wi-Fi, WiMax) for corresponding signal communications. The device 1500 can be a device such as a cellular telephone, a PDA with mobile communications capabilities, and messaging-centric devices. The communication component 1510 also facilitates communications reception from terrestrial radio networks (e.g., broadcast), digital satellite radio networks, and Internet-based radio services networks.

The device 1500 includes a display 1512 for displaying text, images, video, telephony functions (e.g., a Caller ID function), setup functions, and for user input. For example, the display 1512 can also be referred to as a “screen” that can accommodate the presentation of multimedia content (e.g., music metadata, messages, wallpaper, graphics, etc.). The display 1512 can also display videos and can facilitate the generation, editing and sharing of video quotes. A serial I/O interface 1514 is provided in communication with the processor(s) 1502 to facilitate wired and/or wireless serial communications (e.g., USB, and/or IEEE 1394) through a hardwire connection, and other serial input devices (e.g., a keyboard, keypad, and mouse). This supports updating and troubleshooting the device 1500, for example. Audio capabilities are provided with an audio I/O component 1516, which can include a speaker for the output of audio signals related to, for example, indication that the user pressed the proper key or key combination to initiate the user feedback signal. The audio I/O component 1516 also facilitates the input of audio signals through a microphone to record data and/or telephony voice data, and for inputting voice signals for telephone conversations.

The device 1500 can include a slot interface 1518 for accommodating a SIC (Subscriber Identity Component) in the form factor of a card Subscriber Identity Module (SIM) or universal SIM 1520, and interfacing the SIM card 1520 with the processor(s) 1502. However, it is to be appreciated that the SIM card 1520 can be manufactured into the device 1500, and updated by downloading data and software.

The device 1500 can process IP data traffic through the communication component 1510 to accommodate IP traffic from an IP network such as, for example, the Internet, a corporate intranet, a home network, a person area network, etc., through an ISP or broadband cable provider. Thus, VoIP traffic can be utilized by the device 1500 and IP-based multimedia content can be received in either an encoded or a decoded format.

A video processing component 1522 (e.g., a camera) can be provided for decoding encoded multimedia content. The video processing component 1522 can aid in facilitating the generation, editing, and sharing of video quotes. The device 1500 also includes a power source 1524 in the form of batteries and/or an AC power subsystem, which power source 1524 can interface to an external power system or charging equipment (not shown) by a power I/O component 1526.

The device 1500 can also include a video component 1530 for processing video content received and, for recording and transmitting video content. For example, the video component 1530 can facilitate the generation, editing and sharing of video quotes. A location tracking component 1532 facilitates geographically locating the device 1500. As described hereinabove, this can occur when the user initiates the feedback signal automatically or manually. A user input component 1534 facilitates the user initiating the quality feedback signal. The user input component 1534 can also facilitate the generation, editing and sharing of video quotes. The user input component 1534 can include such conventional input device technologies such as a keypad, keyboard, mouse, stylus pen, and/or touch screen, for example.

Referring again to the applications 1506, a hysteresis component 1536 facilitates the analysis and processing of hysteresis data, which is utilized to determine when to associate with the access point. A software trigger component 1538 can be provided that facilitates triggering of the hysteresis component 1536 when the Wi-Fi transceiver 1513 detects the beacon of the access point. A SIP client 1540 enables the device 1500 to support SIP protocols and register the subscriber with the SIP registrar server. The applications 1506 can also include a client 1542 that provides at least the capability of discovery, play and store of multimedia content, for example, music.

The device 1500, as indicated above related to the communication component 1510, includes an indoor network radio transceiver 1513 (e.g., Wi-Fi transceiver). This function supports the indoor radio link, such as IEEE 802.11, for the dual-mode GSM device (e.g., device 1500). The device 1500 can accommodate at least satellite radio services through a device (e.g., handset device) that can combine wireless voice and digital radio chipsets into a single device (e.g., single handheld device).

It is to be appreciated and understood that one or more components (e.g., the devices, discard manager component, base station, core network, or other component) of the systems (e.g., system 100, system 300, system 400, system 1300, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

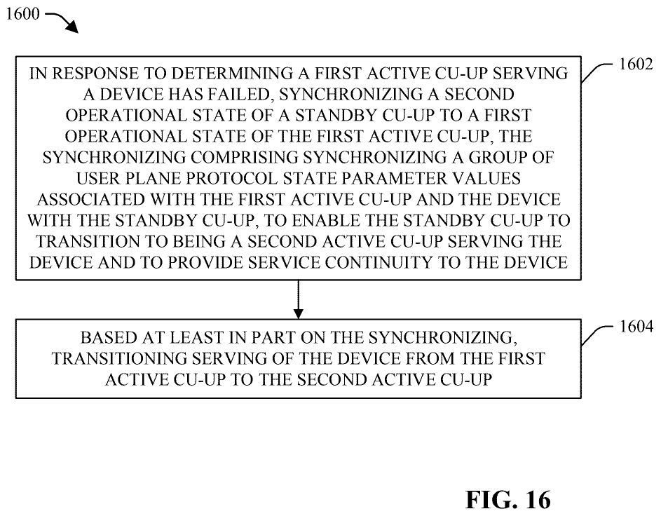

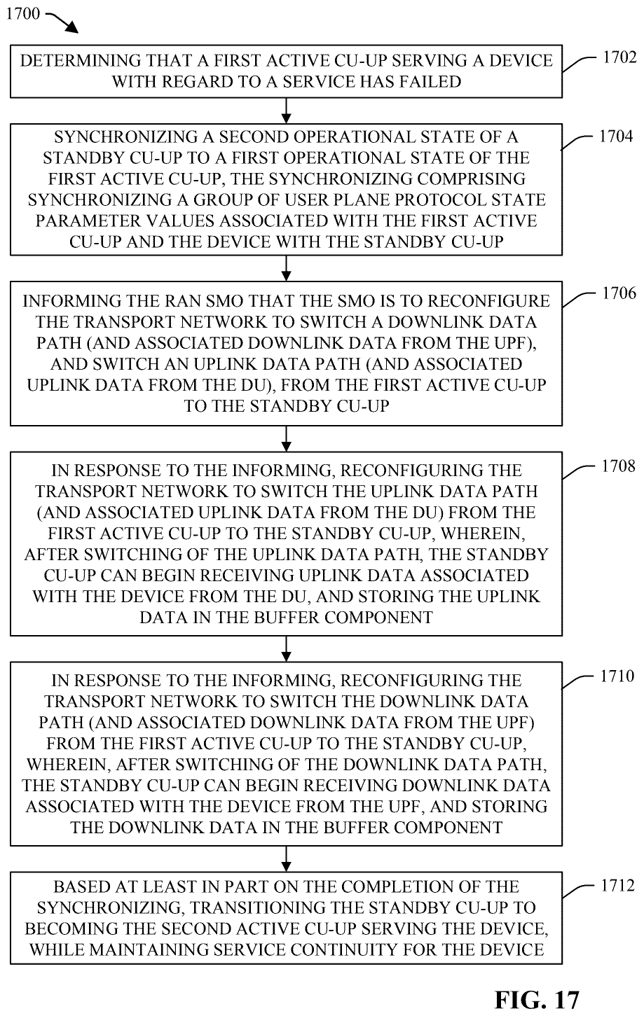

In view of the example systems and/or devices described herein, example methods that can be implemented in accordance with the disclosed subject matter can be further appreciated with reference to flowcharts in FIGS. 16-17. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 16 illustrates a flow chart of an example method 1600 that can desirably (e.g., automatically, dynamically, suitably, reliably, efficiently, enhancedly, and/or optimally) perform and manage CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter. The method 1600 can be employed by, for example, a system comprising a communication network, including a core network, the SMO, and the RAN associated with the SMO and core network. The RAN can comprise the CU-CP, the CU-UPs, the DU, and/or the RU, which can comprise or be associated with the processor component, the data store, and/or other components. The CU-CP can comprise or be associated with the node manager component.

At 1602, in response to determining a first active CU-UP serving a device has failed, a second operational state of a standby CU-UP can be synchronized to a first operational state of the first active CU-UP, the synchronizing comprising synchronizing a group of user plane protocol state parameter values associated with the first active CU-UP and the device with the standby CU-UP, to enable the standby CU-UP to transition to being a second active CU-UP serving the device and to provide service continuity to the device. The device can be utilizing a service. In connection with using that service, the device can be connected to the RAN via the DU and the first active CU-UP (e.g., first active CU-UP node). In connection with or in response to determining that the first active CU-UP serving the device has failed, the CU-CP, employing the node manager component, can synchronize the second operational state of the standby CU-UP to the first operational state of the first active CU-UP. As part of the synchronizing, the node manager component can synchronize or facilitate synchronizing of the group of user plane protocol state parameter values (e.g., group of PDCP parameter values) associated with the first active CU-UP and the device with the standby CU-UP. Such synchronization can enable the standby CU-UP to transition to being the second active CU-UP serving the device and provide service continuity to the device.

At 1604, based at least in part on the synchronizing, serving of the device can be transitioned from the first active CU-UP to the second active CU-UP. The node manager component can transition or facilitate transitioning of the device from being served by the first active CU-UP to being served by the second active CU-UP.

FIG. 17 depicts a flow chart of another example method 1700 that can desirably (e.g., automatically, dynamically, suitably, reliably, efficiently, enhancedly, and/or optimally) perform and manage CU-UP failure mitigation, including synchronizing an active CU-UP and a standby CU-UP, and transitioning from the active CU-UP to the standby CU-UP to serve a device when the active CU-UP fails, in accordance with various aspects and embodiments of the disclosed subject matter. The method 1700 can be employed by, for example, a system comprising a communication network, including a core network, the SMO, and the RAN associated with the SMO and core network. The RAN can comprise the CU-CP, the CU-UPs, the DU, and/or the RU, which can comprise or be associated with the processor component, the data store, and/or other components. The CU-CP can comprise or be associated with the node manager component.

At 1702, a determination can be made that a first active CU-UP serving a device with regard to a service has failed. The device can be utilizing a service. In connection with using that service, the device can be connected to the RAN via the DU and the first active CU-UP (e.g., first active CU-UP node). The node manager component can determine, identify, or detect that the first active CU-UP has failed (e.g., has experienced an SCTP failure or other failure).

At 1704, a second operational state of a standby CU-UP can be synchronized to a first operational state of the first active CU-UP, the synchronizing comprising synchronizing a group of user plane protocol state parameter values associated with the first active CU-UP and the device with the standby CU-UP. The node manager component can synchronize, or initiate or facilitate synchronizing of, the second operational state of the standby CU-UP to the first operational state of the first active CU-UP, wherein the synchronizing can comprise synchronizing the group of user plane protocol state parameter values associated with the first active CU-UP and the device with the standby CU-UP. In some embodiments, to facilitate the synchronizing, the node manager component can request that the DU provide, for each DRB associated with the device and the first active CU-UP, the last downlink PDCP SN received from the first active CU-UP and the last uplink PDCP SN sent to the first active CU-UP. The request can include all of the one or more DRBs associated with (e.g., belonging to) the device. The node manager component can receive those parameter values (e.g., the last downlink PDCP SN received from the first active CU-UP and the last uplink PDCP SN sent to the first active CU-UP) from the DU.

In certain embodiments, to facilitate the synchronizing, the node manager component can communicate a status update request message to the standby CU-UP to request that the standby CU-UP update its status (e.g., as part of synchronizing with the first active CU-UP), wherein the status update request message can comprise the last downlink PDCP SN received from the first active CU-UP and the last uplink PDCP SN sent to the first active CU-UP, with regard to each DRB associated with the device. In response to the status update request message, with regard to each DRB associated with the device, the standby CU-UP can determine, generate, and/or set various user plane protocol state parameter values, based at least in part on the last downlink PDCP SN and the last uplink PDCP SN. For instance, for each DRB associated with the device and present in the status update request message, the standby CU-UP can determine and/or generate the uplink PDCP count as a function of the uplink HFN and the last uplink PDCP SN (e.g., uplink PDCP count=[uplink HFN, last uplink PDCP SN]), and the downlink PDCP count as a function of the downlink HFN and the last downlink PDCP SN (e.g., downlink PDCP count=[downlink HFN, last downlink PDCP SN]). Also, for each DRB associated with the device and present in the status update request message, the standby CU-UP can determine and/or set the PDCP state variables, such as the next transmission value (TX_NEXT), the next reception value (RX_NEXT), the reception delivery value (RX_DELIV), and the reception reorder value (RX_REORD), as TX_NEXT=downlink PDCP count+1, RX_NEXT=uplink PDCP count+1, RX_DELIV=RX_NEXT, and RX_REORD=RX_NEXT, respectively. After the standby CU-UP determines, generates, and/or sets the various user plane protocol state parameter values, the standby CU-UP can communicate a status update response message to the CU-CP (e.g., to the node manager component of the CU-CP) to inform the CU-CP about updating of the status of the standby CU-UP, including the updating of the uplink PDCP count and downlink PDCP count, with regard to each DRB associated with the device.

At 1706, the RAN SMO can be informed that the SMO is to reconfigure the transport network to switch a downlink data path (and associated downlink data from the UPF), and switch an uplink data path (and associated uplink data from the DU), from the first active CU-UP to the standby CU-UP. At 1708, in response to the informing or instructing, the transport network can be reconfigured to switch the uplink data path (and associated uplink data from the DU) from the first active CU-UP to the standby CU-UP, wherein, after switching of the uplink data path, the standby CU-UP can begin receiving uplink data associated with the device from the DU, and storing the uplink data in the buffer component. At 1710, in response to the informing or instructing, the transport network can be reconfigured to switch the downlink data path (and associated downlink data from the UPF) from the first active CU-UP to the standby CU-UP, wherein, after switching of the downlink data path, the standby CU-UP can begin receiving downlink data associated with the device from the UPF, and storing the downlink data in the buffer component. The node manager component can inform or instruct the RAN SMO that the SMO (e.g., the E2E SMO and RAN SMO, respectively) is to reconfigure the transport network to switch the downlink data path (and associated downlink data from the UPF), and switch the uplink data path (and associated uplink data from the DU), from the first active CU-UP to the standby CU-UP. In some embodiments, the reconfiguring of the transport layer and switching of the uplink and downlink data paths to the standby CU-UP can be performed concurrently or in parallel with the synchronizing of the second operational state of a standby CU-UP to the first operational state of the first active CU-UP.

In response to the informing or instructing, the RAN SMO can reconfigure the transport network to switch the uplink data path (and associated uplink data from the DU) from the first active CU-UP to the standby CU-UP. The RAN SMO also can inform the E2E SMO to reconfigure the transport network to switch the downlink data path (and associated downlink data from the UPF) from the first active CU-UP to the standby CU-UP. In response, the E2E can reconfigure the transport network to switch the downlink data path (and associated downlink data from the UPF) from the first active CU-UP to the standby CU-UP. After the reconfiguring of the transport network and switching of the uplink and downlink data paths to the standby CU-UP, the standby CU-UP can begin receiving the uplink data associated with the device from the DU via the uplink data path, and storing (e.g., temporarily storing) the uplink data in the buffer component, and can begin receiving the downlink data associated with the device from the UPF via the downlink data path, and storing (e.g., temporarily storing) the downlink data in the buffer component, while waiting for the synchronization process to be completed.

At 1712, based at least in part on the completion of the synchronizing, the standby CU-UP can be transitioned to becoming the second active CU-UP serving the device, while maintaining service continuity for the device. Based at least in part on, and/or in response to, the completion of the synchronizing, the node manager component can facilitate, or can have facilitated, the transitioning of the standby CU-UP to becoming the second active CU-UP serving the device. After the synchronization is complete, the second active CU-UP can communicate the buffered uplink data from the buffer component, and any subsequent uplink data associated with the device that is received from the DU, to the UPF (e.g., for forwarding to or towards the final destination of the uplink data), and can communicate the buffered downlink data from the buffer component, and any subsequent downlink data associated with the device that is received from the UPF, to the DU (e.g., for forwarding to the device). Due in part to the synchronization process (e.g., the enhanced synchronization process described herein), the buffering of the uplink and downlink data by the standby CU-UP during the synchronization process, and the transitioning of the standby CU-UP to becoming the second active CU-UP serving the device, service continuity can be desirably (e.g., suitably, efficiently, reliably, enhancedly, or optimally) maintained for the device to desirably mitigate (e.g., minimize or reduce) the failure of the first active CU-UP.

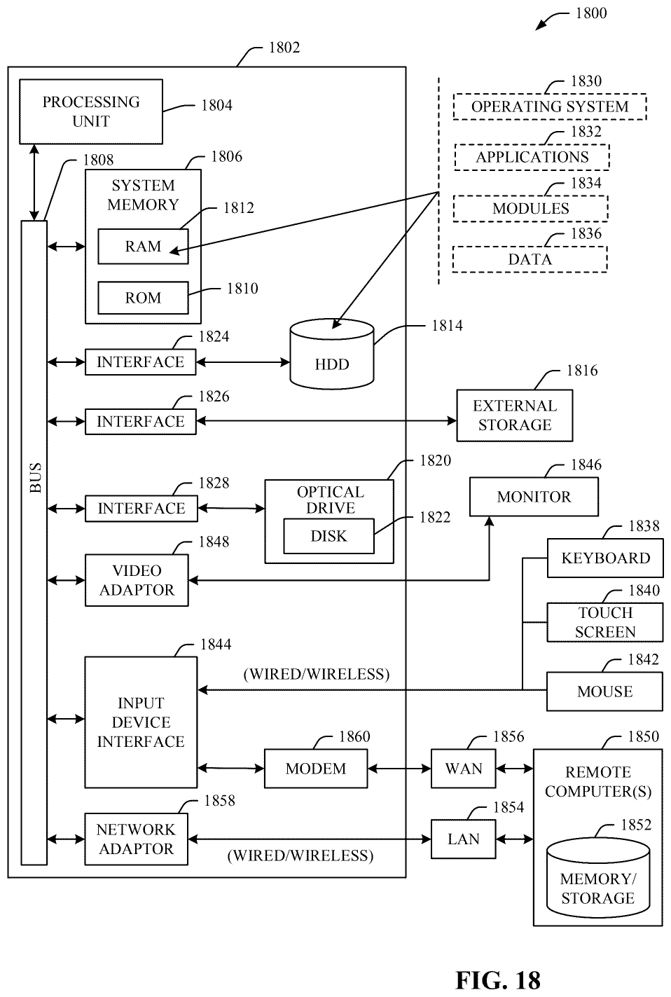

In order to provide additional context for various embodiments described herein, FIG. 18 and the following discussion are intended to provide a brief, general description of a suitable computing environment 1800 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 18, the example environment 1800 for implementing various embodiments of the aspects described herein includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures can also be employed as the processing unit 1804.

The system bus 1808 can be any of several types of bus structure that can further interconnect to a memory bus (with or without a memory controller), a peripheral bus, and a local bus using any of a variety of commercially available bus architectures. The system memory 1806 includes ROM 1810 and RAM 1812. A basic input/output system (BIOS) can be stored in a non-volatile memory such as ROM, erasable programmable read only memory (EPROM), EEPROM, which BIOS contains the basic routines that help to transfer information between elements within the computer 1802, such as during startup. The RAM 1812 can also include a high-speed RAM such as static RAM for caching data.

The computer 1802 further includes an internal hard disk drive (HDD) 1814 (e.g., EIDE, SATA), one or more external storage devices 1816 (e.g., a magnetic floppy disk drive (FDD) 1816, a memory stick or flash drive reader, a memory card reader, etc.) and an optical disk drive 1820 (e.g., which can read or write from a CD-ROM disc, a DVD, a BD, etc.). While the internal HDD 1814 is illustrated as located within the computer 1802, the internal HDD 1814 also can be configured for external use in a suitable chassis (not shown). Additionally, while not shown in environment 1800, a solid state drive (SSD) could be used in addition to, or in place of, an HDD 1814. The HDD 1814, external storage device(s) 1816 and optical disk drive 1820 can be connected to the system bus 1808 by an HDD interface 1824, an external storage interface 1826 and an optical drive interface 1828, respectively. The interface 1824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1812, including an operating system 1830, one or more application programs 1832, other program modules 1834 and program data 1836. All or portions of the operating system, applications, modules, and/or data can also be cached in the RAM 1812. The systems and methods described herein can be implemented utilizing various commercially available operating systems or combinations of operating systems.

Computer 1802 can optionally comprise emulation technologies. For example, a hypervisor (not shown) or other intermediary can emulate a hardware environment for operating system 1830, and the emulated hardware can optionally be different from the hardware illustrated in FIG. 18. In such an embodiment, operating system 1830 can comprise one virtual machine (VM) of multiple VMs hosted at computer 1802. Furthermore, operating system 1830 can provide runtime environments, such as the Java runtime environment or the .NET framework, for applications 1832. Runtime environments are consistent execution environments that allow applications 1832 to run on any operating system that includes the runtime environment. Similarly, operating system 1830 can support containers, and applications 1832 can be in the form of containers, which are lightweight, standalone, executable packages of software that include, e.g., code, runtime, system tools, system libraries and settings for an application.

Further, computer 1802 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1802, e.g., applied at the application execution level or at the operating system (OS) kernel level, thereby enabling security at any level of code execution.

A user can enter commands and information into the computer 1802 through one or more wired/wireless input devices, e.g., a keyboard 1838, a touch screen 1840, and a pointing device, such as a mouse 1842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1804 through an input device interface 1844 that can be coupled to the system bus 1808, but can be connected by other interfaces, such as a parallel port, an IEEE 1394 serial port, a game port, a USB port, an IR interface, a BLUETOOTH® interface, etc.

A monitor 1846 or other type of display device can be also connected to the system bus 1808 via an interface, such as a video adapter 1848. In addition to the monitor 1846, a computer typically includes other peripheral output devices (not shown), such as speakers, printers, etc.

The computer 1802 can operate in a networked environment using logical connections via wired and/or wireless communications to one or more remote computers, such as a remote computer(s) 1850. The remote computer(s) 1850 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1852 is illustrated. The logical connections depicted include wired/wireless connectivity to a local area network (LAN) 1854 and/or larger networks, e.g., a wide area network (WAN) 1856. Such LAN and WAN networking environments are commonplace in offices and companies, and facilitate enterprise-wide computer networks, such as intranets, all of which can connect to a global communications network, e.g., the Internet.

When used in a LAN networking environment, the computer 1802 can be connected to the local network 1854 through a wired and/or wireless communication network interface or adapter 1858. The adapter 1858 can facilitate wired or wireless communication to the LAN 1854, which can also include a wireless access point (AP) disposed thereon for communicating with the adapter 1858 in a wireless mode.

When used in a WAN networking environment, the computer 1802 can include a modem 1860 or can be connected to a communications server on the WAN 1856 via other means for establishing communications over the WAN 1856, such as by way of the Internet. The modem 1860, which can be internal or external and a wired or wireless device, can be connected to the system bus 1808 via the input device interface 1844. In a networked environment, program modules depicted relative to the computer 1802 or portions thereof, can be stored in the remote memory/storage device 1852. It will be appreciated that the network connections shown are example and other means of establishing a communications link between the computers can be used.

When used in either a LAN or WAN networking environment, the computer 1802 can access cloud storage systems or other network-based storage systems in addition to, or in place of, external storage devices 1816 as described above. Generally, a connection between the computer 1802 and a cloud storage system can be established over a LAN 1854 or WAN 1856, e.g., by the adapter 1858 or modem 1860, respectively. Upon connecting the computer 1802 to an associated cloud storage system, the external storage interface 1826 can, with the aid of the adapter 1858 and/or modem 1860, manage storage provided by the cloud storage system as it would other types of external storage. For instance, the external storage interface 1826 can be configured to provide access to cloud storage sources as if those sources were physically connected to the computer 1802.

The computer 1802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, base station, node manager component, state component, buffer component, processor component, device parameter component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
in response to determining a first active central unit-user plane node serving a device has failed, synchronizing, by a system comprising at least one processor, a second operational state of a standby central unit-user plane node to a first operational state of the first active central unit-user plane node, comprising synchronizing a group of user plane protocol state parameter values associated with the first active central unit-user plane node and the device with the standby central unit-user plane node, to enable the standby central unit-user plane node to transition to being a second active central unit-user plane node serving the device and to provide service continuity to the device; and
based on the synchronizing, transitioning, by the system, serving of the device from the first active central unit-user plane node to the second active central unit-user plane node.

2. The method of claim 1, wherein the transitioning further comprises, based on the synchronizing, transitioning the serving of the device from the first active central unit-user plane node to the second active central unit-user plane node without releasing the device from a distributed unit and core network equipment of a core network associated with the device and without performing a reset of a data radio bearer associated with the device, to facilitate providing the service continuity to the device.

3. The method of claim 1, wherein the group of user plane protocol state parameter values comprises an uplink packet-data-convergence-protocol count, a downlink packet-data-convergence-protocol count, a next transmission variable value, a next reception variable value, a reception delivery variable value, or a reception reorder variable value, associated with a data radio bearer associated with the device.

4. The method of claim 1, wherein the synchronizing further comprises:
synchronizing a central unit-user plane configuration of the first active central unit-user plane node with the standby central unit-user plane node; and
synchronizing a device-related configuration of the device with the standby central unit-user plane node.

5. The method of claim 1, further comprising:
communicating, by the system, a status request message to a distributed unit associated with the device, wherein the status request message requests that the distributed unit provide a last downlink packet-data-convergence-protocol sequence number associated with a last downlink data packet received from the first active central unit-user plane node and associated with a data radio bearer associated with the device, and a last uplink packet-data-convergence-protocol sequence number associated with a last uplink data packet associated with the data radio bearer and sent to the first active central unit-user plane node; and
receiving, by the system from the distributed unit, a status response message, wherein the status response message comprises the last downlink packet-data-convergence-protocol sequence number and the last uplink packet-data-convergence-protocol sequence number.

6. The method of claim 1, further comprising:
communicating, by the system, a downlink user data packet to a distributed unit associated with the device, wherein the downlink user data packet comprises a header section that comprises a request for a packet-data-convergence-protocol sequence number report associated with a data radio bearer associated with the device; and
receiving, by the system from the distributed unit, a downlink data delivery status message comprising the packet-data-convergence-protocol sequence number report, wherein the packet-data-convergence-protocol sequence number report comprises a last downlink packet-data-convergence-protocol sequence number associated with a last downlink data packet received from the first active central unit-user plane node and associated with a data radio bearer associated with the device, and a last uplink packet-data-convergence-protocol sequence number associated with a last uplink data packet associated with the data radio bearer and sent to the first active central unit-user plane node.

7. The method of claim 1, further comprising:
communicating, by the system, a status update request message to the standby central unit-user plane node, wherein the status update request message comprises a last downlink packet-data-convergence-protocol sequence number associated with a last downlink data packet received from the first active central unit-user plane node and associated with a data radio bearer associated with the device, and a last uplink packet-data-convergence-protocol sequence number associated with a last uplink data packet associated with the data radio bearer and sent to the first active central unit-user plane node, and wherein the status update request message requests that the standby central unit-user plane node update its status based on the last downlink packet-data-convergence-protocol sequence number and the last uplink packet-data-convergence-protocol sequence number; and
receiving, by the system, from the standby central unit-user plane node, a status update response message that indicates that the status of the standby central unit-user plane node is updated.

8. The method of claim 7, wherein, to facilitate updating the status and the synchronizing, the standby central unit-user plane node determines an uplink packet-data-convergence-protocol count based on the uplink packet-data-convergence-protocol sequence number and an uplink hyper frame number, determines a downlink packet-data-convergence-protocol count based on the downlink packet-data-convergence-protocol sequence number and a downlink hyper frame number, sets a next transmission variable based on the downlink packet-data-convergence-protocol count, sets a next reception variable based on the uplink packet-data-convergence-protocol count, sets a reception delivery variable based on the next reception variable, or sets a reception reorder variable based on the next reception variable, and
wherein the group of user plane protocol state parameter values comprises the uplink packet-data-convergence-protocol count, the downlink packet-data-convergence-protocol count, the next transmission variable value, the next reception variable value, the reception delivery variable value, or the reception reorder variable value.

9. The method of claim 1, further comprising:
informing, by the system, a radio-access-network service-management-and-orchestration node that the radio-access-network service-management-and-orchestration node is to reconfigure network equipment of a transport network to switch a downlink data path, for communication of downlink data from a user plane function node towards the device, from the first active central unit-user plane node to the standby central unit-user plane node; and
informing, by the system, the radio-access-network service-management-and-orchestration node that the radio-access-network service-management-and-orchestration node is to reconfigure the network equipment of the transport network to switch an uplink data path, for communication of uplink data associated with the device from a distributed unit, from the first active central unit-user plane node to the standby central unit-user plane node.

10. The method of claim 9, wherein the radio-access-network service-management-and-orchestration node informs an end-to-end service-management-and-orchestration node that the end-to-end service-management-and-orchestration node is to reconfigure the network equipment of the transport network to switch the downlink data path from the first active central unit-user plane node to the standby central unit-user plane node.

11. The method of claim 9, wherein, after the network equipment of the transport network is reconfigured, the standby central unit-user plane node receives the downlink data from the user plane function node and stores the downlink data in a buffer memory until the synchronizing is complete,
wherein, after the synchronizing is complete, the standby central unit-user plane node, as the second active central unit-user plane node, communicates the downlink data to the distributed unit for delivery to the device,
wherein the standby central unit-user plane node receives the uplink data associated with the device from the distributed unit and stores the uplink data in the buffer memory until the synchronizing is complete, and
wherein, after the synchronizing is complete, the standby central unit-user plane node, as the second active central unit-user plane node, communicates the uplink data to the user plane function node.

12. A system, comprising:
at least one memory that stores computer executable components; and
at least one processor that executes computer executable components stored in the at least one memory, wherein the computer executable components comprise:
a synchronizer that, in response to determining that a first active central unit-user plane node serving a user equipment has failed, synchronizes a second operational state of a standby central unit-user plane node with a first operational state of the first active central unit-user plane node, comprising synchronization of a group of user plane protocol state parameter values associated with the first active central unit-user plane node and the user equipment with the standby central unit-user plane node, to enable the standby central unit-user plane node to be switched to being a second active central unit-user plane node serving the user equipment and provide service continuity to the user equipment; and
a node switcher that switches serving of the user equipment from the first active central unit-user plane node to the second active central unit-user plane node, based on the synchronizing.

13. The system of claim 12, wherein, based on the synchronizing, the node switcher switches the serving of the user equipment from the first active central unit-user plane node to the second active central unit-user plane node without releasing the user equipment from a distributed unit and an access and mobility management function node associated with the user equipment and without performing a reset of a data radio bearer associated with the user equipment, to facilitate providing the service continuity to the user equipment.

14. The system of claim 12, wherein the group of user plane protocol state parameter values comprises an uplink packet-data-convergence-protocol count, a downlink packet-data-convergence-protocol count, a next transmission variable value, a next reception variable value, a reception delivery variable value, or a reception reorder variable value, associated with a data radio bearer associated with the user equipment.

15. The system of claim 12, wherein the synchronizer synchronizes a central unit-user plane configuration of the first active central unit-user plane node with the standby central unit-user plane node, and synchronizes a user equipment-related configuration of the user equipment with the standby central unit-user plane node.

16. The system of claim 12, wherein the synchronizer sends a status request message to a distributed unit associated with the user equipment, wherein the status request message requests that the distributed unit provide a last downlink packet-data-convergence-protocol sequence number associated with a last downlink data packet received from the first active central unit-user plane node and associated with a data radio bearer associated with the user equipment, and a last uplink packet-data-convergence-protocol sequence number associated with a last uplink data packet associated with the data radio bearer and sent to the first active central unit-user plane node,
wherein the synchronizer receives from the distributed unit, a status response message, and wherein the status response message comprises the last downlink packet-data-convergence-protocol sequence number and the last uplink packet-data-convergence-protocol sequence number.

17. The system of claim 12, wherein the synchronizer sends a downlink user data packet to a distributed unit associated with the user equipment, wherein the downlink user data packet comprises a header section that comprises a request for a packet-data-convergence-protocol sequence number report associated with a data radio bearer associated with the user equipment,
wherein the synchronizer receives, from the distributed unit, a downlink data delivery status message comprising the packet-data-convergence-protocol sequence number report, and wherein the packet-data-convergence-protocol sequence number report comprises a last downlink packet-data-convergence-protocol sequence number associated with a last downlink data packet received from the first active central unit-user plane node and associated with a data radio bearer associated with the user equipment, and a last uplink packet-data-convergence-protocol sequence number associated with a last uplink data packet associated with the data radio bearer and sent to the first active central unit-user plane node.

18. The system of claim 12, wherein the synchronizer sends a status update request message to the standby central unit-user plane node, wherein the status update request message comprises a last downlink packet-data-convergence-protocol sequence number associated with a last downlink data packet received from the first active central unit-user plane node and associated with a data radio bearer associated with the user equipment, and a last uplink packet-data-convergence-protocol sequence number associated with a last uplink data packet associated with the data radio bearer and sent to the first active central unit-user plane node, wherein the status update request message requests that the standby central unit-user plane node update its status based on the last downlink packet-data-convergence-protocol sequence number and the last uplink packet-data-convergence-protocol sequence number, and
wherein the synchronizer receives, from the standby central unit-user plane node, a status update response message that indicates that the status of the standby central unit-user plane node is updated.

19. A non-transitory machine-readable medium, comprising executable instructions that, when executed by at least one processor, facilitate performance of operations, comprising:
in response to determining a first active central unit-user plane node serving a user equipment has failed, synchronizing a second operational state of a standby central unit-user plane node with a first operational state of the first active central unit-user plane node, comprising synchronizing a group of packet-data-convergence-protocol state parameter values associated with the first active central unit-user plane node and the user equipment with the standby central unit-user plane node, to facilitate transitioning of the standby central unit-user plane node to become a second active central unit-user plane node serving the user equipment and to provide service continuity to the user equipment; and
based on the synchronizing, transitioning serving of the user equipment from the first active central unit-user plane node to the second active central unit-user plane node.

20. The non-transitory machine-readable medium of claim 19, wherein, to facilitate providing the service continuity to the user equipment, the transitioning further comprises, based on the synchronizing, transitioning the serving of the user equipment from the first active central unit-user plane node to the second active central unit-user plane node without releasing the user equipment from a distributed unit and core network equipment of a core network associated with the user equipment and without performing a reset of a data radio bearer associated with the user equipment, and
wherein the group of packet-data-convergence-protocol state parameter values comprises an uplink packet-data-convergence-protocol count, a downlink packet-data-convergence-protocol count, a next transmission variable value, a next reception variable value, a reception delivery variable value, or a reception reorder variable value, associated with the data radio bearer associated with the user equipment.
